(19) United States
(12) Patent Application Publication
(10) Pub. No.: US 2023/0217972 A1
(43) Pub. Date: Jul. 13, 2023

(54) STEVIOL GLYCOSIDE MALONIC ACID ESTERS

(71) Applicant: CARGILL, INCORPORATED, Wayzata, MN (US)

(72) Inventors: Dan S. GASPARD, Victoria, MN (US); Adam T. ZARTH, St. Louis Park, MN (US)

(73) Assignee: CARGILL, INCORPORATED, Wayzata, MN (US)

(21) Appl. No.: 17/996,658

(22) PCT Filed: Apr. 20, 2021
(86) PCT No.: PCT/US2021/028157

§ 371 Date: Oct. 20, 2022

Related U.S. Application Data
(60) Provisional application No. 63/012,601, filed on Apr. 20, 2020.

(51) Int. Cl. A23L 27/30; A23L 2/60; B01D 11/02; B01D 15/36

(52) U.S. Cl. CPC A23L 27/36; A23L 2/60; B01D 11/0288; B01D 15/363

(57) ABSTRACT

Various embodiments disclosed relate to steviol glycoside malonic acid esters (SGMAs). The present invention provides one or more SGMAs or salts thereof, compositions including the one or more SGMAs or salts thereof, and methods of forming a composition that includes one or more steviol glycoside malonic acid esters (SGMAs) or salts thereof. A composition including one or more SGMAs or salts thereof can be a sweetener or a sweetened composition such as a beverage concentrate, a sweetened beverage, a carbonated soft drink, a solid food stuff, a pharmaceutical composition, a nutritional supplement, or a dental composition.

### CROSS-REFERENCE TO RELATED APPLICATIONS

This application claims the benefit of U.S. Provisional Patent Application No. 63/012,601, filed Apr. 20, 2020, which is hereby incorporated by reference herein in its entirety.

### BACKGROUND

In recent decades, consumers have increasingly sought low-calorie alternatives to calorie-rich products. Steviol glycosides offer a non-caloric alternative to traditional caloric sweeteners such as sugar, glucose, sucrose, and/or fructose. Steviol glycosides are a class of sweet-tasting glycosylated diterpene compounds commonly obtained from the leaves of Stevia rebaudiana. Various steviol glycosides are known, some of which provide a sugar-like taste profile and are 150 to 450 times sweeter than sugar. Such compounds are typically characterized by a single steviol backbone and the presence of differing arrangements of glycosidic carbohydrate residues at positions C13 and C19.

### SUMMARY OF THE INVENTION

In various aspects, the present invention provides a steviol glycoside malonic acid ester (SGMA) or salt thereof. In various aspects, the SGMA has the structure:

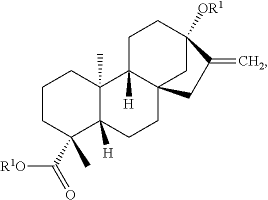

or a salt thereof. At each occurrence R¹ may be independently chosen from —H, a malonic acid ester or a salt thereof, and a glycosidically-bonded primary sugar. At each occurrence the primary sugar may be independently chosen from glucose, xylose, and rhamnose, and at each occurrence the primary sugar independently optionally includes a secondary sugar glycosidically-bonded to the primary sugar, a malonic acid ester or a salt thereof bonded to the primary sugar, or a combination thereof. At each occurrence the secondary sugar, if present, may be independently chosen from glucose, xylose, and rhamnose, and at each occurrence the secondary sugar independently optionally includes a tertiary sugar glycosidically-bonded to the secondary sugar, a malonic acid ester or a salt thereof bonded to the secondary sugar, or a combination thereof. At each occurrence the tertiary sugar, if present, may be independently chosen from glucose, xylose, and rhamnose, and at each occurrence the tertiary sugar independently optionally includes a malonic acid ester or a salt thereof bonded to the tertiary sugar. The SGMA includes at least one of the primary sugars and at least one of the malonic acid ester groups or a salt thereof.

In various aspects, the present invention provides a composition including one or more steviol glycoside malonic acid esters (SGMAs) or salts thereof. The composition may be, for example, a sweetener or a sweetened composition such as a beverage concentrate, a sweetened beverage, a carbonated soft drink, a solid food stuff, a pharmaceutical composition, a nutritional supplement, or a dental composition. 0-5% (wt) of the composition may be one or more of quercetin, kaempferol, myricetin, fisetin, galangin, isorhamnetin, pachypodol, rhamnazin, pyranoflavonols, furanoflavonols, luteolin, apigenin, tangeritin, taxifolin (or dihydroquercetin), dihydrokaempferol, hesperetin, naringenin, eriodictyol, homoeriodictyol, genistein, daidzein, glycitein, hesperidin, naringin, rutin, quercitrin, luteolin-glucoside, quercetin-xyloside, cyanidin, delphinidin, malvidin, pelargonidin, peonidin, and petunidin; or 0-3% (wt) of the composition may be one or more of malonate, malonic acid, oxalate, oxalic acid, lactate, lactic acid, succinate, succinic acid, malate, malic acid, citrate, and citric acid; or 0-1% (wt) of the composition may be one or more of sulfate, sulfuric acid, phosphate, phosphoric acid, nitrate, nitric acid, nitrite, nitrous acid, chloride, hydrochloric acid, ammonia, ammonium, tannic acid, monoglycerides, diglycerides, triglycerides, glucose, fructose, sucrose, galactose, ribose, trehalose, trehalulose, lactose, maltose, isomaltose, isomaltulose, mannose, tagatose, arabinose, rhamnose, xylose, dextrose, erythrose, threose, maltotriose, panose, glycerol, sorbitol, mannitol, xylitol, maltitol, lactitol, erythritol, isomalt, and inositol; or 0-0.5% (wt) of the composition may be one or more of tartrate, tartaric acid, pyruvate, pyruvic acid, fumarate, fumaric acid, ascorbic acid, sorbate, sorbic acid, acetate, acetic acid, and chlorophyll, or a combination thereof.

In various aspects, the present invention provides a method of purifying one or more SGMAs or salts thereof from stevia leaf material. The method includes extracting the stevia leaf material with an extraction solution including water, a water-miscible alcohol, or a combination thereof, so that the extraction solution includes a stevia leaf extract. The method also includes chromatographing the stevia leaf extract, to provide the one or more purified SMGAs or salts thereof.

In various aspects, the present invention provides a method of forming a composition including one or more steviol glycoside malonic acid esters (SGMAs) or salts thereof. The method includes purifying one or more SGMAs or salts thereof from a stevia leaf material. The purifying includes extracting the stevia leaf material with an extraction solution including water, a water-miscible alcohol, or a combination thereof, so that the extraction solution includes a stevia leaf extract. The purifying also includes chromatographing the stevia leaf extract, to provide the one or more SGMAs or salts thereof. The method also includes combining the one or more SGMAs or salts thereof with one or more steviol glycosides, to form the composition including one or more SGMAs or salts thereof. In various aspects, the steviol glycosides are extracted from a different stevia leaf material than the stevia leaf material from which the SGMAs or salts thereof are purified.

In various aspects, the present invention provides a method of making a sweetener or sweetened composition. The method includes combining an SGMA component that includes at least 80 wt % of one or more steviol glycoside malonic acid esters (SGMAs) or salts thereof with a second component that includes at least one sweetener chosen from steviol glycosides, mogrosides, a sugar, aspartame, sucralose, neotame, and brazzein.

In various aspects, the present invention provides a beverage. The beverage includes a steviol glycoside malonic acid ester (SGMA) or salt thereof having the structure:

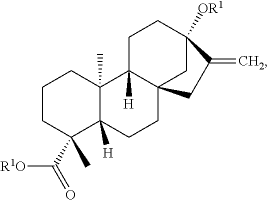

or a salt thereof. At each occurrence R¹ is independently chosen from —H, a malonic acid ester or a salt thereof, and a glycosidically-bonded primary sugar. At each occurrence the primary sugar is independently chosen from glucose, xylose, and rhamnose, and at each occurrence the primary sugar independently optionally includes a secondary sugar glycosidically-bonded to the primary sugar, a malonic acid ester or a salt thereof bonded to the primary sugar, or a combination thereof. At each occurrence the secondary sugar, if present, is independently chosen from glucose, xylose, and rhamnose, and at each occurrence the secondary sugar independently optionally includes a tertiary sugar glycosidically-bonded to the secondary sugar, a malonic acid ester or a salt thereof bonded to the secondary sugar, or a combination thereof. At each occurrence the tertiary sugar, if present, is independently chosen from glucose, xylose, and rhamnose, and at each occurrence the tertiary sugar independently optionally includes a malonic acid ester or a salt thereof bonded to the tertiary sugar. The SGMA includes at least one of the primary sugars and at least one of the malonic acid ester groups or a salt thereof. The beverage has a concentration of the one or more SGMAs, salts thereof, or combination thereof of 200 ppm to 1,000 ppm. The composition includes less than 0.3 wt % of malonate, malonic acid, oxalate, oxalic acid, lactate, lactic acid, succinate, succinic acid, malate, or malic acid; or less than 0.05 wt % of pyruvate, pyruvic acid, fumarate, fumaric acid, tartrate, tartaric acid, sorbate, sorbic acid, acetate, or acetic acid; or less than about 0.05 wt % of chlorophyll.

Various embodiments of the present invention provide advantages over other sweeteners, steviol glycosides, compositions including the same, and methods of making the same. For example, in various embodiments, the SGMA or salt thereof of the present invention can provide higher water solubility than other sweeteners such as other steviol glycosides. For example, in various embodiments, the SGMA or salt thereof of the present invention can provide more rapid dissolution in water than other sweeteners such as other steviol glycosides. For example, in various embodiments, the SGMA or salt thereof of the present invention can provide less sweetness linger than other sweeteners such as other steviol glycosides.

In a typical steviol glycoside extraction from stevia plant leaf, the steviol glycoside malonic acid ester (SGMA) or salt thereof is destroyed and/or is not part of the final steviol glycosides produced. For example, conventional stevia leaf processing operations remove and/or destroy SGMAs. Decoloring steps, such as adding iron chloride, chemically modify the SGMAs, which are then precipitated and removed. Other decoloring steps, such as anion exchange chromatography, bind the SGMAs to the stationary phase, along with other colored molecules, while the desired traditional steviol glycosides are passed through and collected for further processing. Typical regeneration procedures for these anionic resin columns destroy the SGMAs that were bound to the resin during processing. In contrast, the method of the present invention can extract SGMAs from stevia plant leaf with less or minimal destruction or loss of SGMAs or salts thereof.

### BRIEF DESCRIPTION OF THE FIGURES

The drawings illustrate generally, by way of example, but not by way of limitation, various embodiments of the present invention.

FIG. 1 illustrates a mass spectrum of a flow injection analysis of a stevia leaf extract.

FIG. 2 illustrates the percentage of malonated glucose-containing steviol glycosides in stevia leaf extracts from 1,251 plants, compared to traditional (non-malonated) steviol glycosides, in accordance with various aspects.

FIGS. 3a-e illustrate various steviol glycoside species isolated using chromatographic separation, in accordance with various aspects.

FIGS. 4a-d illustrate various steviol glycoside species isolated using chromatographic separation, in accordance with various aspects.

FIGS. 5a-d illustrate various steviol glycoside species isolated using chromatographic separation, in accordance with various aspects.

FIG. 6 illustrates a mass spectrum of a malonated steviol glycoside, in accordance with various aspects.

FIG. 7 illustrates possible fragmentation to explain peaks seen in the mass spectrum of FIG. 6, in accordance with various aspects.

FIG. 8 illustrates a zoomed mass spectrum illustrating free malonated glucose in stevia leaf extract, in accordance with various aspects.

FIG. 9 illustrates an isolated malonated steviol glycoside, in accordance with various aspects.

FIG. 10 illustrates a ¹H NMR spectrum of the isolated malonated steviol glycoside shown in FIG. 9, in accordance with various aspects.

FIG. 11 illustrates a ¹³C NMR spectrum of the isolated malonated steviol glycoside shown in FIG. 9, in accordance with various aspects.

FIG. 12 illustrates an isolated malonated steviol glycoside, in accordance with various aspects.

FIG. 13 illustrates a ¹H NMR spectrum of the isolated malonated steviol glycoside shown in FIG. 12, in accordance with various aspects.

FIG. 14 illustrates a ¹³C NMR spectrum of the isolated malonated steviol glycoside shown in FIG. 12, in accordance with various aspects.

FIG. 15 illustrates an isolated malonated steviol glycoside, in accordance with various aspects.

FIG. 16 illustrates a ¹H NMR spectrum of the isolated malonated steviol glycoside shown in FIG. 15, in accordance with various aspects.

FIG. 17 illustrates a ¹³C NMR spectrum of the isolated malonated steviol glycoside shown in FIG. 15, in accordance with various aspects.

FIG. 18 illustrates an isolated malonated steviol glycoside, in accordance with various aspects.

FIG. 19 illustrates a ¹H NMR spectrum of the isolated malonated steviol glycoside shown in FIG. 18, in accordance with various aspects.

FIG. 20 illustrates an isolated malonated steviol glycoside, in accordance with various aspects.

FIG. 21 illustrates a ¹H NMR spectrum of the isolated malonated steviol glycoside shown in FIG. 20, in accordance with various aspects.

FIG. 22 illustrates an FIA spectrum of aqueous stevia leaf extract before treatment, in accordance with various aspects.

FIG. 23 illustrates an FIA spectrum of an aqueous stevia extract after anionic resin treatment, in accordance with various aspects.

FIG. 24 illustrates an FIA spectrum of an aqueous stevia extract after iron(III) chloride treatment and filtration, in accordance with various aspects.

FIG. 25 illustrates a UHPLC/UV chromatogram of a purified malonated steviol glycoside, in accordance with various aspects.

### DETAILED DESCRIPTION OF THE INVENTION

Reference will now be made in detail to certain embodiments of the disclosed subject matter. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In this document, the term “parts per million” or “ppm” means part per million on a weight basis unless context dictates otherwise.

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that about 0 wt % to about 5 wt % of the composition is the material, or about 0 wt % to about 1 wt %, or about 5 wt % or less, or less than or equal to about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

The term “hydrocarbon” as used herein refers to a molecule or functional group that includes carbon and hydrogen atoms. The term can also refer to a molecule or functional group that normally includes both carbon and hydrogen atoms but wherein all the hydrogen atoms are substituted with other functional groups.

### Steviol Glycoside Malonic Acid Ester.

Various aspects of the present invention provide a steviol glycoside malonic acid ester (SGMA) or salt thereof. The SGMA includes one or more malonic acid ester groups, such as 1-3 malonic acid ester groups or more (e.g., no more than 1-3 malonic acid ester groups), 2 malonic acid ester groups (e.g., no more than 2 malonic acid ester groups), or 1 malonic acid ester group (e.g., no more than 1 malonic acid ester group). The malonic acid ester group can have the structure:

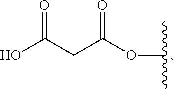 [SMILES: *OC(=O)CC(=O)O]

or a salt thereof.

The SGMA salt can be any suitable salt of the SGMA. For example, the salt can be a malonic acid salt including a counterion that is sodium, potassium, calcium, magnesium, ammonium, or a combination thereof. The salt can be a malonic acid salt including a counterion that is sodium, potassium, or a combination thereof.

The SGMA can be any suitable steviol glycoside including a malonic acid ester group. The SGMA can include one or more of glucose, xylose, rhamnose, or a combination thereof. The SGMA can have the structure:

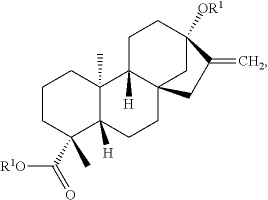

or a salt thereof. At each occurrence R¹ can be independently chosen from —H, a malonic acid ester or a salt thereof, and a glycosidically-bonded primary sugar. At each occurrence the primary sugar can be independently chosen from glucose, xylose, and rhamnose, and at each occurrence the primary sugar can independently optionally include a secondary sugar glycosidically-bonded to the primary sugar, a malonic acid ester or a salt thereof bonded to the primary sugar, or a combination thereof. At each occurrence the secondary sugar, if present, can be independently chosen from glucose, xylose, and rhamnose, and at each occurrence the secondary sugar can independently optionally include a tertiary sugar glycosidically-bonded to the secondary sugar, a malonic acid ester or a salt thereof bonded to the secondary sugar, or a combination thereof. At each occurrence the tertiary sugar, if present, can be independently chosen from glucose, xylose, and rhamnose, and at each occurrence the tertiary sugar can independently optionally include a malonic acid ester or a salt thereof bonded to the tertiary sugar. The SGMA includes at least one of the primary sugars and at least one of the malonic acid ester groups or a salt thereof.

The SGMA can be free of the secondary sugars. The SGMA can include at least one of the secondary sugars. The SGMA can be free of the tertiary sugars. The SGMA can include at least one of the tertiary sugars.

The SGMA can have the structure:

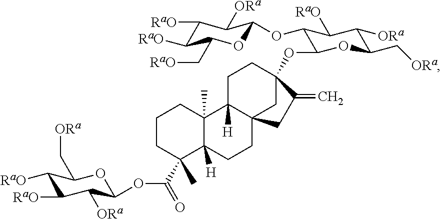

or a salt thereof. At each occurrence R^{a} can be independently chosen from —H, a malonic acid ester or a salt thereof, and a sugar. At each occurrence the sugar can be independently chosen from glucose, xylose, and rhamnose. At each occurrence the sugar can independently optionally include a malonic acid ester or a salt thereof bonded to the sugar. For example, each of the sugars can independently be free of a malonic acid ester or a salt thereof bonded thereto, or can include a malonic acid ester or a salt thereof bonded thereto. The SGMA includes at least one malonic acid ester or a salt thereof (e.g., one or more R^{a} is a malonic acid ester or a salt thereof, one or more sugars include a malonic acid ester or a salt thereof bonded thereto, or a combination thereof).

At each occurrence R^{a} can be independently chosen from —H and a malonic acid ester or a salt thereof, wherein at least one R^{a} is a malonic acid ester or a salt thereof. The SGMA can have the structure:

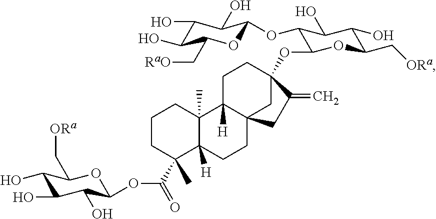

or a salt thereof. The SGMA can have the structure:

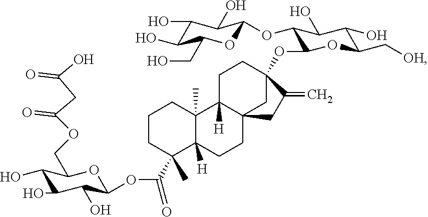

or a salt thereof.

The SGMA can have the structure:

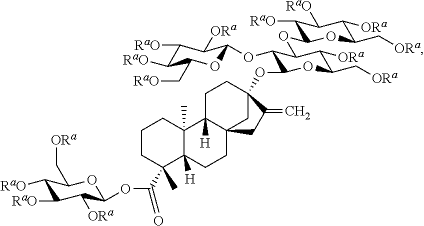

or a salt thereof. At each occurrence R^{a} can be independently chosen from —H, a malonic acid ester or a salt thereof, and a sugar. At each occurrence the sugar can be independently chosen from glucose, xylose, and rhamnose. At each occurrence the sugar can independently optionally include a malonic acid ester or a salt thereof bonded to the sugar. For example, each of the sugars can independently be free of a malonic acid ester or a salt thereof bonded thereto, or can include a malonic acid ester or a salt thereof bonded thereto. The SGMA includes at least one malonic acid ester or a salt thereof (e.g., one or more R^{a} is a malonic acid ester or a salt thereof, one or more sugars include a malonic acid ester or a salt thereof bonded thereto, or a combination thereof).

At each occurrence R^{a} can be independently chosen from —H and a malonic acid ester or a salt thereof, wherein at least one R^{a} is a malonic acid ester or a salt thereof. The SGMA can have the structure:

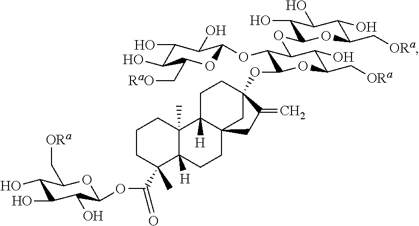

or a salt thereof. The SGMA can have the structure:

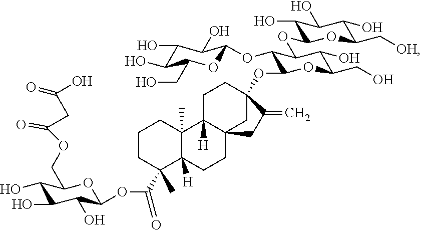

or a salt thereof. The SGMA can have the structure:

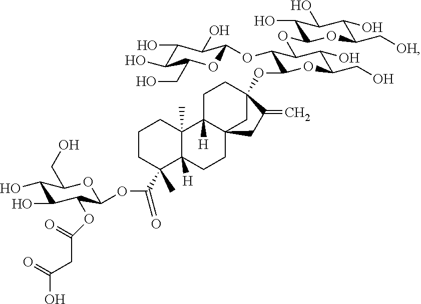

or a salt thereof.

The SGMA can have the structure:

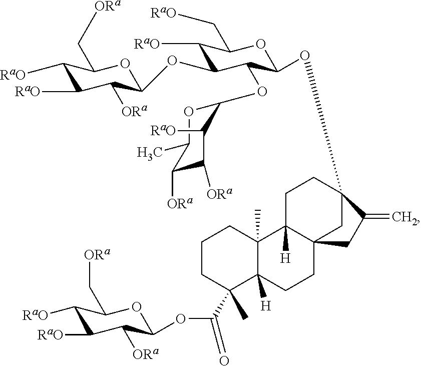

or a salt thereof. At each occurrence R^{a} can be independently chosen from —H, a malonic acid ester or a salt thereof, and a sugar. At each occurrence the sugar can be independently chosen from glucose, xylose, and rhamnose. At each occurrence the sugar can independently optionally include a malonic acid ester or a salt thereof bonded to the sugar. For example, each of the sugars can independently be free of a malonic acid ester or a salt thereof bonded thereto, or can include a malonic acid ester or a salt thereof bonded thereto. The SGMA includes at least one malonic acid ester or a salt thereof (e.g., one or more R^{a} is a malonic acid ester or a salt thereof, one or more sugars include a malonic acid ester or a salt thereof bonded thereto, or a combination thereof).

At each occurrence R^{a} can be independently chosen from —H and a malonic acid ester or a salt thereof, wherein at least one R^{a} is a malonic acid ester or a salt thereof. The SGMA can have the structure:

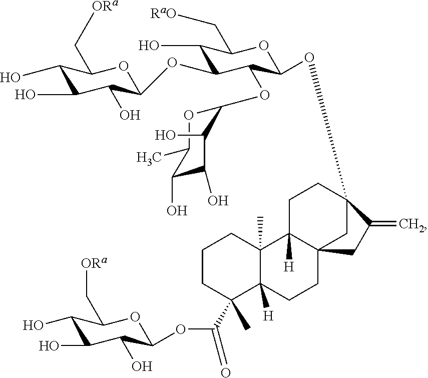

or a salt thereof. The SGMA can have the structure:

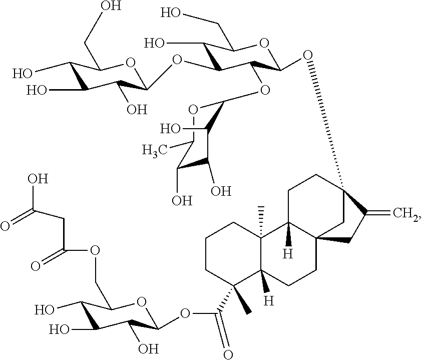

or a salt thereof.

The SGMA can have the structure:

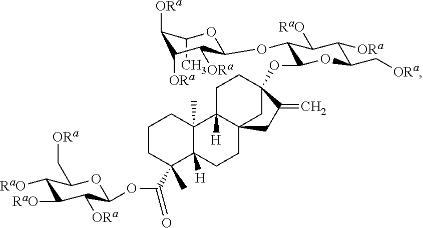

or a salt thereof. At each occurrence R^{a} can be independently chosen from —H, a malonic acid ester or a salt thereof, and a sugar. At each occurrence the sugar can be independently chosen from glucose, xylose, and rhamnose. At each occurrence the sugar can independently optionally include a malonic acid ester or a salt thereof bonded to the sugar. For example, each of the sugars can independently be free of a malonic acid ester or a salt thereof bonded thereto, or can include a malonic acid ester or a salt thereof bonded thereto. The SGMA includes at least one malonic acid ester or a salt thereof (e.g., one or more R^{a} is a malonic acid ester or a salt thereof, one or more sugars include a malonic acid ester or a salt thereof bonded thereto, or a combination thereof).

At each occurrence R^{a} can be independently chosen from —H and a malonic acid ester or a salt thereof, wherein at least one R^{a} is a malonic acid ester or a salt thereof. The SGMA can have the structure:

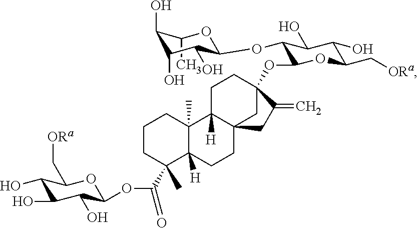

or a salt thereof.

The SGMA can have the structure:

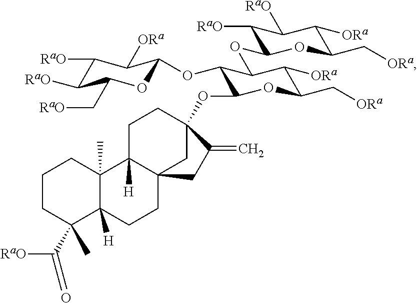

or a salt thereof. At each occurrence R^{a} can be independently chosen from —H, a malonic acid ester or a salt thereof, and a sugar. At each occurrence the sugar can be independently chosen from glucose, xylose, and rhamnose. At each occurrence the sugar can independently optionally include a malonic acid ester or a salt thereof bonded to the sugar. For example, each of the sugars can independently be free of a malonic acid ester or a salt thereof bonded thereto, or can include a malonic acid ester or a salt thereof bonded thereto. The SGMA includes at least one malonic acid ester or a salt thereof (e.g., one or more R^{a} is a malonic acid ester or a salt thereof, one or more sugars include a malonic acid ester or a salt thereof bonded thereto, or a combination thereof).

At each occurrence R^{a} can be independently chosen from —H and a malonic acid ester or a salt thereof, wherein at least one R^{a} is a malonic acid ester or a salt thereof. The SGMA can have the structure:

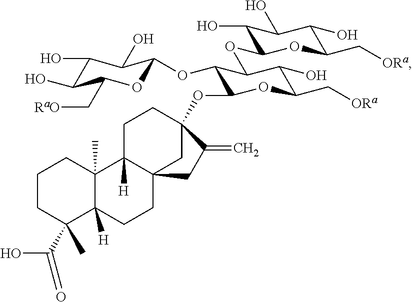

or a salt thereof.

The SGMA can have the structure:

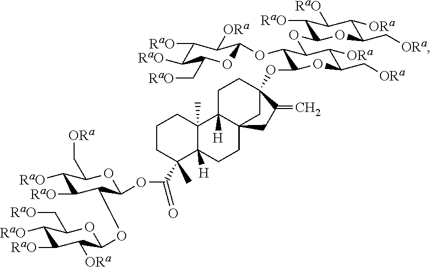

or a salt thereof. At each occurrence R^{a} can be independently chosen from —H, a malonic acid ester or a salt thereof, and a sugar. At each occurrence the sugar can be independently chosen from glucose, xylose, and rhamnose. At each occurrence the sugar can independently optionally include a malonic acid ester or a salt thereof bonded to the sugar. For example, each of the sugars can independently be free of a malonic acid ester or a salt thereof bonded thereto, or can include a malonic acid ester or a salt thereof bonded thereto. The SGMA includes at least one malonic acid ester or a salt thereof (e.g., one or more R^{a} is a malonic acid ester or a salt thereof, one or more sugars include a malonic acid ester or a salt thereof bonded thereto, or a combination thereof).

At each occurrence R^{a} can be independently chosen from —H and a malonic acid ester or a salt thereof, wherein at least one R^{a} is a malonic acid ester or a salt thereof. The SGMA can have the structure:

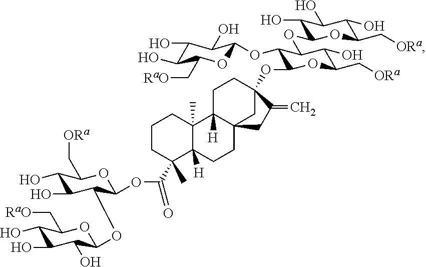

or a salt thereof.

The SGMA can have the structure:

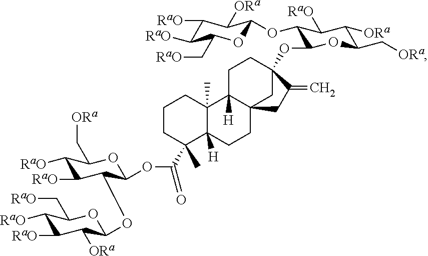

or a salt thereof. At each occurrence R^{a} can be independently chosen from —H, a malonic acid ester or a salt thereof, and a sugar. At each occurrence the sugar can be independently chosen from glucose, xylose, and rhamnose. At each occurrence the sugar can independently optionally include a malonic acid ester or a salt thereof bonded to the sugar. For example, each of the sugars can independently be free of a malonic acid ester or a salt thereof bonded thereto, or can include a malonic acid ester or a salt thereof bonded thereto. The SGMA includes at least one malonic acid ester or a salt thereof (e.g., one or more R^{a} is a malonic acid ester or a salt thereof, one or more sugars include a malonic acid ester or a salt thereof bonded thereto, or a combination thereof).

At each occurrence R^{a} can be independently chosen from —H and a malonic acid ester or a salt thereof, wherein at least one R^{a} is a malonic acid ester or a salt thereof. The SGMA can have the structure:

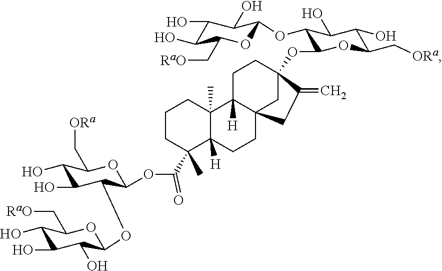

or a salt thereof.

The SGMA can have the structure:

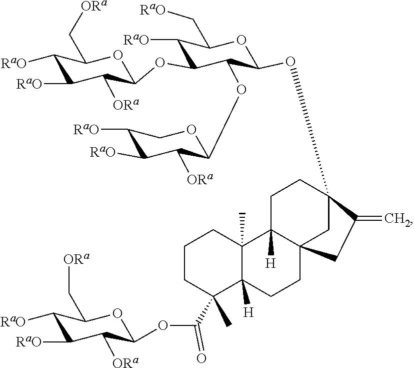

or a salt thereof. At each occurrence R^{a} can be independently chosen from —H, a malonic acid ester or a salt thereof, and a sugar. At each occurrence the sugar can be independently chosen from glucose, xylose, and rhamnose. At each occurrence the sugar can independently optionally include a malonic acid ester or a salt thereof bonded to the sugar. For example, each of the sugars can independently be free of a malonic acid ester or a salt thereof bonded thereto, or can include a malonic acid ester or a salt thereof bonded thereto. The SGMA includes at least one malonic acid ester or a salt thereof (e.g., one or more R^{a} is a malonic acid ester or a salt thereof, one or more sugars include a malonic acid ester or a salt thereof bonded thereto, or a combination thereof).

At each occurrence R^{a} can be independently chosen from —H and a malonic acid ester or a salt thereof, wherein at least one R^{a} is a malonic acid ester or a salt thereof. The SGMA can have the structure:

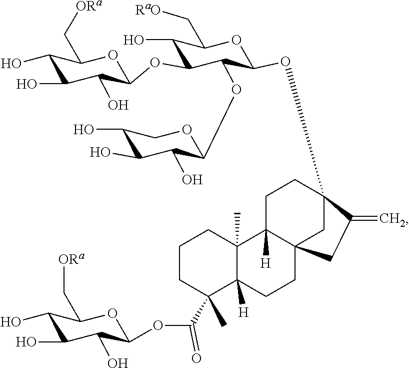

or a salt thereof. The SGMA can have the structure:

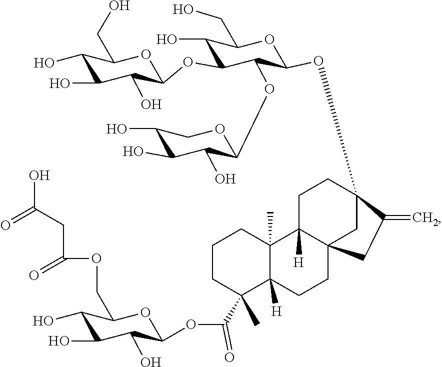

or a salt thereof.

The SGMA can have any suitable water solubility. For example, the SGMA can have a water solubility of 40 wt % or more (e.g., the SGMA is dissolved in deionized water to form an aqueous solution that is 40 wt % or more SGMA, and the SGMA remains in solution for at least one day at room temperature), or 0 wt % to 40 wt %, or 20 wt % to 40 wt %, or 0 wt %, or 1 wt % or less, or less than, equal to, or greater than 2 wt %, 4, 6, 8, 10, 15, 20, 25, 30, 35, or 40 wt % or more.

### Composition Including Steviol Glycoside Malonic Acid Ester.

Various aspects of the present invention provide a composition including one or more of the SGMAs, salts thereof, or a combination thereof, described herein. The composition can be a sweetener or a sweetened composition. Sweetened compositions can include a beverage concentrate (e.g., a throw syrup used to make a carbonated beverage via addition of water and carbonation, or a water enhancer used to flavor or sweeten still water), a sweetened beverage (e.g., tea or a carbonated soft drink), a solid food stuff, a pharmaceutical composition, a nutritional supplement, or a dental composition. The composition can be a sweetener, e.g., a dry tabletop sweetener or a liquid sweetener concentrate, having a relatively high concentration of the SGMAs, salts thereof, or a combination thereof. The sweetened composition can be a food product or a beverage with a relatively lower concentration of the SGMAs, salts thereof, or a combination thereof. Sweetened compositions can be formed by combining compositions that are sweeteners with a sweetenable composition that includes the other ingredients.

The one or more SGMAs, salts thereof, or the combination thereof, can be any suitable proportion of the composition. The one or more SGMAs, salts thereof, or the combination thereof, can be 0.001 wt % to 100 wt % of the composition, 5 wt % to 100 wt %, 10 wt % to 100 wt %, 0.01 wt % to 90 wt %, 0.01 wt % to 30 wt %, or 0.001 wt % or more, or less than, equal to, or greater than 0.005 wt %, 0.01, 0.05, 0.1, 0.5, 1, 2, 3, 4, 5, 6, 8, 10, 12, 14, 16, 18, 20, 22, 24, 26, 28, 30, 32, 34, 36, 38, 40, 45, 50, 55, 60, 65, 70, 75, 80, 82, 84, 86, 88, 90, 92, 94, 95, 96, 97, 98, 99, 99.9, 99.99 wt %, or 99.999 wt % or less of the composition. Compositions that are sweeteners can have any suitable concentration of the one or more SGMAs, salts thereof, or combination thereof, such as 0.2 wt % to 100 wt %, or 5 wt % to 100 wt %. Compositions that are beverages such as carbonated soft drinks can have any suitable concentration of the one or more SGMAs, salts thereof, or combination thereof, such as 0.01 wt % to 0.2 wt %, or 0.02 wt % to 0.1 wt %, or 0.03 wt % to 0.07 wt %.

The composition can have any suitable concentration of the one or more SGMAs, salts thereof, or combination thereof, such as 100 ppm to 500,000 ppm (i.e., parts per million by weight), 100 ppm to 2,000 ppm, 200 ppm to 1,000 ppm, 300 ppm to 700 ppm, or 100 ppm or more, or less than, equal to, or greater than 150 ppm, 200, 250, 300, 350, 400, 450, 500, 550, 600, 650, 700, 750, 800, 850, 900, 950, 1,000, 1,100, 1,200, 1,300, 1,400, 1,500, 1,600, 1,700, 1,800, 1,900, 2,000, 2,200, 2,400, 2,600, 2,800, 3,000, 3,500, 4,000, 5,000, 6,000, 8,000, 10,000, 20,000, 50,000, 100,000, 200,000, 300,000, 400,000 ppm, or 500,000 ppm or less. Compositions that are sweeteners can have any suitable concentration of the one or more SGMAs, salts thereof, or combination thereof, such as 100,000 ppm to 500,000 ppm or more. Compositions that are beverages such as carbonated soft drinks can have any suitable concentration of the one or more SGMAs, salts thereof, or combination thereof, such as 100 ppm to 2,000 ppm, 200 to 1,000 ppm, or 300 ppm to 700 ppm.

The composition can be substantially free (e.g., 0 wt %) of non-malonated steviol glycosides and salts thereof. The composition can include one or more non-malonated steviol glycosides, salts thereof, or a combination thereof. The non-malonated steviol glycosides or salts thereof can be any suitable non-malonated steviol glycosides or salts thereof, such as stevioside, rebaudioside A, rebaudioside C, dulcoside A, rebaudioside B, rebaudioside D, rebaudioside E, rebaudioside M, rebaudioside O, rebaudioside N, rebaudioside F, salts thereof, or a combination thereof. The composition can have any suitable ratio (i.e., mass ratio) of non-malonated steviol glycosides, salts thereof, or a combination thereof to the one or more SGMAs, such as 0.001:1 to 1000:1,0.1:1 to 1000:1, 2:1 to 1000:1,0.1:1 to 10:1, 0.3:1 to 3:1, 0.5:1 to 2:1, or 0.001:1 or more, or less than, equal to, or greater than 0.005:1, 0.01:1, 0.05:1, 0.1:1, 0.2:1, 0.3:1, 0.4:1, 0.5:1, 0.6:1, 0.7:1, 0.8:1, 0.9:1, 1.0:1, 1.1:1, 1.2:1, 1.3:1, 1.4:1, 1.5:1, 1.6:1, 1.7:1, 1.8:1, 1.9:1, 2:1, 2.5:1, 3:1, 4:1, 5:1, 6:1, 8:1, 10:1, 15:1, 20:1, 25:1, 50:1, 100:1, 150:1, 200:1, 250:1, 500:1, 750:1, or 1000:1 or less.

The composition can be an aqueous composition. For example, 20 wt % or more, or at least 20 wt %, or the composition can be water. Any suitable amount of the composition can be water, such as both 5 wt % or more and less than, equal to, or greater than 6, 8, 10, 15, 20, 25, 30, 35, 40, 45, 50, 55, 60, 65, 70, 75, 80, 82, 84, 86, 88, 90, 92, 94, 96, 98, 99, 99.9, 99.99 wt % or more.

The composition can have any suitable pH, such as a pH of 1 to 12, 1 to 9, 1.7 to 4, 2.5 to 3.5 (e.g., carbonated soft drink), 1.7 to 2.0 (e.g., throw syrup), or 1 or more, or less than, equal to, or greater than 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.8, 4.0, 4.2, 4.4, 4.6, 4.8, 5, 5.5, 6, 6.5, 7, 7.5, 8, 8.5, 9, 10, 11, or 12 or less.

The composition can have a solid form (e.g., is not a liquid composition), such as a powder or granulated solid. The composition can be a freeze-dried power. The composition can be a sweetener. The composition in a solid form can have any suitable water solubility. For example, the solid composition can have a water solubility of 80 wt % or more (e.g., the solid composition is dissolved in deionized water to form an aqueous solution that is 80 wt % dissolved solid composition and the solid composition remains in solution for at least one day at 22 ° C.), or 0 wt % to 80 wt %, or 40 wt % to 80 wt %, or 0 wt %, or 1 wt % or less, or less than, equal to, or greater than 2 wt %, 4, 6, 8, 10, 15, 20, 25, 30, 35, 40, 45, 50, 55, 60, 65, 70, 75 wt %, or 80 wt % or more.

The composition can be a solid food stuff. The composition can be a snack bar, a dried fruit product, a cookie, a cereal, a chocolate, a chewing gum, a candy, a cake, a donut, or a combination thereof. The composition can be a pharmaceutical composition, a nutritional supplement, or a dental composition.

The composition can be a sweetened beverage. The composition can be a chocolate milk, a tea, an energy drink, a drinkable yogurt, a flavored water, or a combination thereof. The composition can be a carbonated soft drink. The composition can be a throw syrup (e.g., a syrup that can be used to make a beverage, such as to make a carbonated soft drink via addition of water and carbonation). The composition can be a sweetener, and can be a liquid, a solid, or a combination thereof.

The composition can include any suitable one or more additional components, or can be substantially free of one or more additional components. Examples of the one or more additional components include a stability modifier, a stabilizer (e.g., a material that stabilizes the composition to acidic conditions), a microbial stabilizer (e.g., sodium benzoate or sodium sorbate), another sweetener (i.e. other than the one or more SGMAs or salts thereof), a bulking agent, erythritol, a desiccant, an anti-caking agent, or a combination thereof.

The composition can be substantially free of stevia plant matter that is not soluble in water or a water-miscible alcohol such as ethanol or methanol.

In various aspects, the composition can be stable under acidic conditions in the absence of steviol glycoside stabilizers that stabilize steviol glycosides to acidic conditions (e.g., prevent degradation). For example, the composition can be substantially free of steviol glycoside stabilizers (e.g., 0 wt % stabilizers), and the SGMAs in the composition can be stable (e.g., less than 20 wt %, 10 wt %, 5 wt %, 1 wt %, or less than 0.1 wt % degradation of the SGMA or salt thereof at 22 ° C. over 4 weeks, 2 months, 4 months, 6 months, 1 year, 2 years, or 3 years or more) at a pH of 1 to 9, 1.7 to 4, 2.5 to 3.5, 1.7 to 2.0, 4 to 9, or 1 or more, or less than, equal to, or greater than 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.8, 4.0, 4.2, 4.4, 4.6, 4.8, 5, 5.5, 6, 6.5, 7, 7.5, 8, 8.5, or 9 or less.

The composition can be substantially free of materials from stevia leaf that are removed during a chromatographic separation to obtain the SGMA or salts thereof of the composition. For example, the composition can be substantially free of organic acid, citric acid, malic acid, phosphate, sulfate, colored bodies, chlorophyll, flavonoids, rutin, quercetin, quercitrin, glucose, fructose, amino acids, proteins, MCQAs, DCQAs, or a combination thereof.

Some compounds can adversely impact the flavor, aroma, color, or other sensory aspects of the composition including SGMAs or salts thereof. In various aspects, the composition does not include one or more of the compounds shown in Table 1, or any combination thereof, above the disclosed preferred content levels. These levels may be appropriate for compositions that are predominantly SGMAs, such a composition for later use in a sweetener or sweetened composition. All preferred content levels are stated as weight percentage on a dry weight basis. For those compounds listed that are acids, the compound may be present in acid form and/or in salt form.

TABLE 1

| Class of | Preferred Content | % wt of compounds in solid (dry) |
|---|---|---|
| compounds | Level (% wt) | compositions |
| Organic acids | <3%, preferably | malonate, malonic acid, oxalate, oxalic acid, |
| | <2%, <1%, or 0% | lactate, lactic acid, succinate, succinic acid, |
| | | malate, malic acid, citrate, citric acid |
| | <0.5%, preferably | tartrate, tartaric acid, pyruvate, pyruvic acid, |
| | <0.25% or 0% | fumarate, fumaric acid, ascorbic acid, sorbate, |
| | | sorbic acid, acetate, acetic acid |
| Inorganic acids | <1%, preferably | sulfate, sulfuric acid, phosphate, phosphoric |
| | <0.5% or 0% | acid, nitrate, nitric acid, nitrite, nitrous acid, |
| | | chloride, hydrochloric acid, ammonia, |
| | | ammonium |
| Flavanoids, | <5%, preferably | quercetin, kaempferol, myricetin, fisetin, |
| isoflavanoids, | <4%, <3%, or <2%, | galangin, isorhamnetin, pachypodol, |
| and | more preferably | rhamnazin, pyranoflavonols, furanoflavonols, |
| neoflavanoids | <1%, <0.5%, or 0% | luteolin, apigenin, tangeritin, taxifolin (or |
| | | dihydroquercetin), dihydrokaempferol, |
| | | hesperetin, naringenin, eriodictyol, |
| | | homoeriodictyol, genistein, daidzein, glycitein |
| Flavanoid | <5%, preferably | hesperidin, naringin, rutin, quercitrin, luteolin- |
| glycosides | <4%, <3%, or <2%, | glucoside, quercetin-xyloside |
| | more preferably | |
| | <1%, <0.5%, or 0% | |
| Anthocyanidins | <5%, preferably | cyanidin, delphinidin, malvidin, pelargonidin, |
| | <4%, <3%, or <2%, | peonidin, petunidin |
| | more preferably | |
| | <1%, <0.5%, or 0% | |
| Tannins | <1%, preferably | tannic acid |
| | <0.5%, <0.25%, | |
| | or 0% | |
| Amino acids + | <0.1%, preferably | alanine, arginine, asparagine, aspartic acid, |
| total protein | <0.05%, or 0% | cysteine, glutamine, glutamic acid, glycine, |
| | | histidine, isoleucine, leucine, lysine, |
| | | methionine, phenylalanine, proline, serine, |
| | | threonine, tryptophan, tyrosine, and valine |
| Total Fat | <1%, preferably | monoglycerides, diglycerides, triglycerides |
| | <0.5%, <0.25%, | |
| | or 0% | |
| Monosaccharides, | <1% | glucose, fructose, sucrose, galactose, ribose, |
| disaccharides, | | trehalose, trehalulose, lactose, maltose, |
| and | | isomaltose, isomaltulose, mannose, tagatose, |
| polysaccharides | | arabinose, rhamnose, xylose, dextrose, |
| | | erythrose, threose, maltotriose, panose |
| Sugar alcohols | <1% | glycerol, sorbitol, mannitol, xylitol, maltitol, |
| | | lactitol, erythritol, isomalt, inositol |
| Dietary fiber | <0.1%, preferably | acacia (arabic) gum, agar-agar, algin-alginate, |
| | <0.05% or 0% | arabynoxylan, beta-glucan, beta mannan, |
| | | carageenan gum, carob or locust bean gum, |
| | | fenugreek gum, galactomannans, gellan gum, |
| | | glucomannan or konjac gum, guar gum, |
| | | hemicellulose, inulin, karaya gum, pectin, |
| | | polydextrose, psyllium husk mucilage, resistant |
| | | starches, tara gum, tragacanth gum, xanthan |
| | | gum, cellulose, chitin, and chitosan |
| Steviol glycoside | <55% | stevioside; steviolbioside; rubusoside; 13- and |
| compounds | | 19-SMG; dulcosides A, B, C, D; and |
| | | rebaudiosides A, B, C, D, E, F, I, M, N, O, T |
| Saponins | <2%, preferably | glycosylated ursolic acid and glycosylated |
| | <1%, <0.5%, | oleanolic acid |
| | <0.25%, or 0% | |
| Terpenes other | <2%, preferably | eugenol, geraniol, geranial, alpha-ionone, beta- |
| than saponins | <1%, <0.5%, | ionone, epoxy-ionone, limonene, linalool, |
| and steviol | <0.25%, or 0% | linalool oxide, nerol, damascenone |
| glycoside | | |
| compounds | | |
| Lipid oxidation | <2%, preferably | Decanone, decenal, nonenal, octenal, heptenal, |
| products | <1%, <0.5%, | hexenal, pentenal, pentenol, pentenone, |
| | <0.25%, or 0% | hexenone, hydroxynonenal, malondialdehyde |
| Polycyclic | <0.1%, preferably | Acenaphthene, Acenaphthylene, Anthracene, |
| Aromatic | <0.05% or 0% | Benzo(a)anthracene, Benzo(a)pyrene, |
| Hydrocarbons | | Benzo(b)fluoranthene, Benzo(ghi)perylene, |
| | | Benzo(k)fluoranthene, Chrysene, |
| | | Dibenzo(a,h)anthracene, Fluoranthene, |
| | | Fluorene, Indeno(1,2,3-cd)pyrene, |
| | | Naphthalene, Phenanthrene, Pyrene |
| Other | <0.1%, preferably | chlorophyll, furans, furan-containing |
| compounds | <0.05% or 0% | chemicals, theobromine, theophylline, and |
| | | trigonelline |
| | <1%, preferably | saponins |
| | <0.5%, <0.25%, | |
| | or 0% | |

In one aspect, the composition in a solid (dry) form does not include one or more of the following compounds in Table 2, or any combination thereof, above the disclosed preferred content levels. By way of example, these levels may be appropriate for compositions that are sweeteners combining SGMAs with another sweetener, such as a tabletop sweetener that includes SGMAs, steviol glycosides, and a bulking agent such as erythritol. All preferred content levels are stated as weight percentage on a dry weight basis. For those compounds listed that are acids, the compound may be present in acid form and/or in salt form.

TABLE 2

| Class of | Preferred Content | % wt of compounds in solid (dry) |
|---|---|---|
| compounds | Level (% wt) | composition |
| Organic acids | <3%, preferably | Malonate, malonic acid, Oxalate, oxalic acid, |
| | <2%, <1%, or 0% | Lactate, lactic acid, Succinate, succinic acid, |
| | | Malate, malic acid, Citrate, citric acid |
| | <0.5%, preferably | Tartrate, tartaric acid, Pyruvate, pyruvic acid, |
| | <0.25% or 0% | Fumarate, fumaric acid, Ascorbic acid, Sorbate, |
| | | sorbic acid, Acetate, acetic acid |
| Inorganic acids | <1%, preferably | Sulfate, sulfuric acid, Phosphate, phosphoric |
| | <0.5% or 0% | acid, Nitrate, nitric acid, Nitrite, nitrous acid, |
| | | Chloride, hydrochloric acid, Ammonia, |
| | | ammonium |
| Flavanoids, | <5%, preferably | Quercetin, Kaempferol, Myricetin, Fisetin, |
| isoflavanoids, | <4%, <3%, or <2%, | Galangin, Isorhamnetin, Pachypodol, |
| and | more preferably | Rhamnazin, Pyranoflavonols, Furanoflavonols, |
| neoflavanoids | <1%, <0.5%, or 0% | Luteolin, Apigenin, Tangeritin, Taxifolin (or |
| | | Dihydroquercetin), Dihydrokaempferol, |
| | | Hesperetin, Naringenin, Eriodictyol, |
| | | Homoeriodictyol, Genistein, Daidzein, |
| | | Glycitein |
| Flavanoid | <5%, preferably | Hesperidin, Naringin, Rutin, Quercitrin, |
| glycosides | <4%, <3%, or <2%, | luteolin-glucoside, quercetin-xyloside |
| | more preferably | |
| | <1%, <0.5%, or 0% | |
| Anthocyanidins | <5%, preferably | Cyanidin, Delphinidin, Malvidin, Pelargonidin, |
| | <4%, <3%, or <2%, | Peonidin, Petunidin |
| | more preferably | |
| | <1%, <0.5%, or 0% | |
| Tannins | <1%, preferably | Tannic acid |
| | <0.5%, <0.25%, | |
| | or 0% | |
| Amino acids + | <0.1%, preferably | Alanine, arginine, asparagine, aspartic acid, |
| total protein | <0.05%, or 0% | cysteine, glutamine, glutamic acid, glycine, |
| | | histidine, isoleucine, leucine, lysine, |
| | | methionine, phenylalanine, proline, serine, |
| | | threonine, tryptophan, tyrosine, and valine |
| Total Fat | <1%, preferably | Monoglycerides, diglycerides, triglycerides |
| | <0.5%, <0.25%, | |
| | or 0% | |
| Monosaccharides, | <1% | Glucose, fructose, sucrose, galactose, ribose, |
| disaccharides, | | trehalose, trehalulose, lactose, maltose, |
| and | | isomaltose, isomaltulose, mannose, tagatose, |
| polysaccharides | | arabinose, rhamnose, xylose, dextrose, |
| | | erythrose, threose, and maltotriose, panose |
| Sugar alcohols | <1% | Glycerol, Sorbitol, mannitol, xylitol, maltitol, |
| | | lactitol, erythritol, isomalt, inositol |
| Dietary fiber | <0.1%, preferably | Acacia (arabic) gum, Agar-agar, Algin-alginate, |
| | <0.05% or 0% | Arabynoxylan, Beta-glucan, Beta mannan, |
| | | Carageenan gum, Carob or locust bean gum, |
| | | Fenugreek gum, Galactomannans, Gellan gum, |
| | | Glucomannan or konjac gum, Guar gum, |
| | | Hemicellulose, Inulin, Karaya gum, Pectin, |
| | | Polydextrose, Psyllium husk mucilage, |
| | | Resistant starches, Tara gum, Tragacanth gum, |
| | | Xanthan gum, Cellulose, Chitin, and Chitosan |
| Steviol glycoside | <75% | Stevioside; steviolbioside; rubusoside; 13- and |
| compounds | | 19-SMG; Dulcosides A, B, C, D; and |
| | | rebaudiosides A, B, C, D, E, F, I, M, N, O, T |
| Saponins | <1%, preferably | glycosylated ursolic acid and glycosylated |
| | <0.5%, <0.25%, | oleanolic acid |
| | or 0% | |
| Terpenes other | <1%, preferably | eugenol, geraniol, geranial, alpha-ionone, beta- |
| than saponins | <0.5%, <0.25%, | ionone, epoxy-ionone, limonene, linalool, |
| and steviol | or 0% | linalool oxide, nerol, damascenone |

glycoside
compounds

| | | |
|---|---|---|
| Lipid oxidation | <1%, preferably | Decanone, decenal, nonenal, octenal, heptenal, |
| products | <0.5%, <0.25%, | hexenal, pentenal, pentenol, pentenone, |
| | or 0% | hexenone, hydroxynonenal, malondialdehyde |
| Polycyclic | <0.05%, preferably | Acenaphthene, Acenaphthylene, Anthracene, |
| Aromatic | <0.01% or 0% | Benzo(a)anthracene, Benzo(a)pyrene, |
| Hydrocarbons | | Benzo(b)fluoranthene, Benzo(ghi)perylene, |
| | | Benzo(k)fluoranthene, Chrysene, |
| | | Dibenzo(a,h)anthracene, Fluoranthene, |
| | | Fluorene, Indeno(1,2,3-cd)pyrene, Naphthalene, |
| | | Phenanthrene, Pyrene |
| Other | <0.1%, preferably | chlorophyll, furans, furan-containing chemicals, |
| compounds | <0.05% or 0% | theobromine, theophylline, and trigonelline |

In one aspect, the composition does not include one or more of the following compounds in Table 3, or any combination thereof, above the disclosed preferred content levels. These preferred content levels are stated as weight percentage of a liquid composition (e.g., a liquid sweetener or a beverage concentrate, such as a throw syrup or a water enhancer). For those compounds listed that are acids, the compound may be present in acid form and/or in salt form, taking into account either may be dissociated in the composition.

TABLE 3

| | Preferred | |
|---|---|---|
| Class of | Content Level | |
| compounds | (% wt) | % (wt) of compounds in liquid compositions |
| Organic acids | <0.3%, preferably | Malonate, malonic acid, Oxalate, oxalic acid, |
| | <0.2%, <0.1%, | Lactate, lactic acid, Succinate, succinic acid, |
| | or 0% | Malate, malic acid |
| | <0.05%, | Tartrate, tartaric acid, Pyruvate, pyruvic acid, |
| | preferably | Fumarate, fumaric acid, Ascorbic acid, |
| | <0.025% or 0% | Sorbate, sorbic acid, Acetate, acetic acid |
| Inorganic acids | <1%, preferably | Sulfate, sulfuric acid, Nitrate, nitric acid, |
| | <0.05% or 0% | Nitrite, nitrous acid, Chloride, hydrochloric |
| | | acid, Ammonia, ammonium |
| Flavanoids, | <0.5%, preferably | Quercetin, Kaempferol, Myricetin, Fisetin, |
| isoflavanoids, and | <0.4%, <0.3%, or | Galangin, Isorhamnetin, Pachypodol, |
| neoflavanoids | <0.2%, more | Rhamnazin, Pyranoflavonols, Furanoflavonols, |
| | preferably <0.1%, | Luteolin, Apigenin, Tangeritin, Taxifolin (or |
| | <0.05%, or 0% | Dihydroquercetin), Dihydrokaempferol, |
| | | Hesperetin, Naringenin, Eriodictyol, |
| | | Homoeriodictyol, Genistein, Daidzein, |
| | | Glycitein |
| Flavanoid | <0.5%, preferably | Hesperidin, Naringin, Rutin, Quercitrin, |
| glycosides | <0.4%, <0.3%, or | luteolin-glucoside, quercetin-xyloside |
| | <0.2%, more | |
| | preferably <0.1%, | |
| | <0.05%, or 0% | |
| Anthocyanidins | <0.5%, preferably | Cyanidin, Delphinidin, Malvidin, Pelargonidin, |
| | <0.4%, <0.3%, or | Peonidin, Petunidin |
| | <0.2%, more | |
| | preferably <0.1%, | |
| | <0.05%, or 0% | |
| Tannins | <0.1%, preferably | Tannic acid |
| | <0.05%, <0.025%, | |
| | or 0% | |
| Amino acids + | <0.01% preferably | Alanine, arginine, asparagine, aspartic acid, |
| total protein | <0.005%, or 0% | cysteine, glutamine, glutamic acid, glycine, |
| | | histidine, isoleucine, leucine, lysine, |
| | | methionine, phenylalanine, proline, serine, |
| | | threonine, tryptophan, tyrosine, and valine |
| Total Fat | <0.1%, preferably | Monoglycerides, diglycerides, triglycerides |
| | <0.05%, <0.025%, | |
| | or 0% | |
| Monosaccharides, | <0.1% | Glucose, fructose, sucrose, galactose, ribose, |
| disaccharides, | | trehalose, trehalulose, lactose, maltose, |
| and | | isomaltose, isomaltulose, mannose, tagatose, |
| polysaccharides | | arabinose, rhamnose, xylose, dextrose, |
| | | erythrose, threose, and maltotriose, panose |
| Sugar alcohols | <0.1% | Glycerol, Sorbitol, mannitol, xylitol, maltitol, |
| | | lactitol, erythritol, isomalt, inositol |
| Dietary fiber | <0.01%, | Acacia (arabic) gum, Agar-agar, Algin- |
| | preferably | alginate, Arabynoxylan, Beta-glucan, Beta |
| | <0.005% or 0% | mannan, Carageenan gum, Carob or locust |
| | | bean gum, Fenugreek gum, Galactomannans, |
| | | Gellan gum, Glucomannan or konjac gum, |
| | | Guar gum, Hemicellulose, Inulin, Karaya gum, |
| | | Pectin, Polydextrose, Psyllium husk mucilage, |
| | | Resistant starches, Tara gum, Tragacanth gum, |
| | | Xanthan gum, Cellulose, Chitin, and Chitosan |
| Saponins | <0.5%, preferably | glycosylated ursolic acid and glycosylated |
| | <0.4%, <0.3%, or | oleanolic acid |
| | <0.2%, more | |
| | preferably <0.1%, | |
| | <0.05%, or 0% | |
| Terpenes other | <0.5%, preferably | eugenol, geraniol, geranial, alpha-ionone, beta- |
| than steviol | <0.4%, <0.3%, or | ionone, epoxy-ionone, limonene, linalool, |
| glycoside | <0.2%, more | linalool oxide, nerol, damascenone |
| compounds and | preferably <0.1%, | |
| saponins | <0.05%, or 0% | |
| Lipid oxidation | <0.5%, preferably | Decanone, decenal, nonenal, octenal, heptenal, |
| products | <0.4%, <0.3%, or | hexenal, pentenal, pentenol, pentenone, |
| | <0.2%, more | hexenone, hydroxynonenal, malondialdehyde |
| | preferably <0.1%, | |
| | <0.05%, or 0% | |
| Polycyclic | <0.01% (100 | Acenaphthene, Acenaphthylene, Anthracene, |
| Aromatic | ppm), preferably | Benzo(a)anthracene, Benzo(a)pyrene, |
| Hydrocarbons | <0.005% (50 | Benzo(b)fluoranthene, Benzo(ghi)perylene, |
| | ppm), or 0% | Benzo(k)fluoranthene, Chrysene, |
| | | Dibenzo(a,h)anthracene, Fluoranthene, |
| | | Fluorene, Indeno(1,2,3-cd)pyrene, |
| | | Naphthalene, Phenanthrene, Pyrene |
| Other compounds | <0.05%, | chlorophyll, furans, furan-containing |
| | preferably <0.01% | chemicals, theobromine, theophylline, and |
| | or 0% | trigonelline |

In one aspect, the composition is a beverage and does not include one or more of the following compounds listed in Table 4, or any combination thereof, at the disclosed wt % cutoffs. All preferred content levels are stated as weight percentage of the total weight of the beverage. For those compounds listed that are acids, the compound may be present in acid form and/or in salt form, taking into account that either may be dissociated in the beverage.

TABLE 4

| Class of | Preferred Content | % (wt) of compounds in compositions that |
|---|---|---|
| compounds | Level (% wt) | are beverages |
| Organic acids | <0.1%, preferably | Malonate, malonic acid, Oxalate, oxalic acid, |
| | <0.05%, <0.025%, | Pyruvate, pyruvic acid, Fumarate, fumaric acid |
| | or 0% | |
| Inorganic acids | <1%, preferably | Sulfate, sulfuric acid, Nitrate, nitric acid, |
| | <0.05% or 0% | Nitrite, nitrous acid, Ammonia, ammonium |
| Flavanoids, | <0.5%, preferably | Quercetin, Kaempferol, Myricetin, Fisetin, |
| isoflavanoids, | <0.4%, <0.3%, or | Galangin, Isorhamnetin, Pachypodol, |
| and | <0.2%, more | Rhamnazin, Pyranoflavonols, Furanoflavonols, |
| neoflavanoids | preferably <0.1%, | Luteolin, Apigenin, Tangeritin, Taxifolin (or |
| | <0.05%, or 0% | Dihydroquercetin), Dihydrokaempferol, |
| | | Hesperetin, Naringenin, Eriodictyol, |
| | | Homoeriodictyol, Genistein, Daidzein, |
| | | Glycitein |
| Flavanoid | <0.5%, preferably | Hesperidin, Naringin, Rutin, Quercitrin, |
| glycosides | <0.4%, <0.3%, or | luteolin-glucoside, quercetin-xyloside |
| | <0.2%, more | |
| | preferably <0.1%, | |
| | <0.05%, or 0% | |
| Anthocyanidins | <0.5%, preferably | Cyanidin, Delphinidin, Malvidin, Pelargonidin, |
| | <0.4%, <0.3%, or | Peonidin, Petunidin |
| | <0.2%, more | |
| | preferably <0.1%, | |
| | <0.05%, or 0% | |
| Tannins | <0.1%, preferably | Tannic acid |
| | <0.05%, <0.025%, | |
| | or 0% | |
| Amino acids + | <5%, preferably | Alanine, arginine, asparagine, aspartic acid, |
| total protein | <1%, <0.5%, <0.1% | cysteine, glutamine, glutamic acid, glycine, |
| | <0.05%, or 0% | histidine, isoleucine, leucine, lysine, |
| | | methionine, phenylalanine, proline, serine, |
| | | threonine, tryptophan, tyrosine, and valine |
| Total Fat | <0.5%, preferably | Monoglycerides, diglycerides, triglycerides |
| | <0.1%, <0.05%, | |
| | <0.025%, or 0% | |
| Dietary fiber | <5%, preferably | Acacia (arabic) gum, Agar-agar, Algin- |
| | <1%, <0.5%, <0.1% | alginate, Arabynoxylan, Beta-glucan, Beta |
| | <0.05%, or 0% | mannan, Carageenan gum, Carob or locust |
| | | bean gum, Fenugreek gum, Galactomannans, |
| | | Gellan gum, Glucomannan or konjac gum, |
| | | Guar gum, Hemicellulose, Inulin, Karaya gum, |
| | | Pectin, Polydextrose, Psyllium husk mucilage, |
| | | Resistant starches, Tara gum, Tragacanth gum, |
| | | Xanthan gum, Cellulose, Chitin, and Chitosan |
| Saponins | <0.1%, preferably | glycosylated ursolic acid and glycosylated |
| | <0.05%, <0.025%, | oleanolic acid |
| | or 0% | |
| Terpenes other | <0.1%, preferably | eugenol, geraniol, geranial, alpha-ionone, beta- |
| than saponins | <0.05%, <0.025%, | ionone, epoxy-ionone, limonene, linalool, |
| and steviol | or 0% | linalool oxide, nerol, damascenone |
| glycoside | | |
| compounds | | |
| Lipid oxidation | <0.1%, preferably | Decanone, decenal, nonenal, octenal, heptenal, |
| products | <0.05%, <0.025%, | hexenal, pentenal, pentenol, pentenone, |
| | or 0% | hexenone, hydroxynonenal, malondialdehyde |
| Polycyclic | <0.001% (10 ppm), | Acenaphthene, Acenaphthylene, Anthracene, |
| Aromatic | preferably | Benzo(a)anthracene, Benzo(a)pyrene, |
| Hydrocarbons | <0.0005% (5 ppm), | Benzo(b)fluoranthene, Benzo(ghi)perylene, |
| | or 0% | Benzo(k)fluoranthene, Chrysene, |
| | | Dibenzo(a,h)anthracene, Fluoranthene, |
| | | Fluorene, Indeno(1,2,3-cd)pyrene, |
| | | Naphthalene, Phenanthrene, Pyrene |
| Other | <0.05%, preferably | chlorophyll, furans, furan-containing |
| compounds | <0.01% or 0% | chemicals, theobromine, theophylline, and |
| | | trigonelline |

Method of Purifying Steviol Glycoside Malonic Acid Ester from Stevia Leaf Material.

Various aspects of the present invention provide a method of purifying the SGMA or salt thereof described herein from stevia leaf material. As used herein, “purifying” or “to purify” mean increasing the purity of a material and are not intended to designate a particular level of purity unless otherwise specified. The method includes extracting the stevia leaf material with an extraction solution including water, a water-miscible alcohol, or a combination thereof, so that the extraction solution includes a stevia leaf extract. The method includes chromatographing the stevia leaf extract, to provide the SGMA or salt thereof.

Various aspects of the present invention provides a method of forming a composition including one or more steviol glycoside malonic acid esters (SGMAs) or salts thereof. The method includes purifying one or more SGMAs or salts thereof from a stevia leaf material. The purifying includes extracting the stevia leaf material with an extraction solution including water, a water-miscible alcohol, or a combination thereof, so that the extraction solution includes a stevia leaf extract. The purifying also includes chromatographing the stevia leaf extract, to provide the one or more SGMAs or salts thereof. The method also includes combining the one or more SGMAs or salts thereof with one or more steviol glycosides, to form the composition including one or more SGMAs or salts thereof. In various aspects, the steviol glycosides are extracted from a different stevia leaf material than the stevia leaf material from which the SGMAs or salts thereof are purified. The chromatographing can form a post-chromatography composition that is free of or has limited content of compounds that can adversely impact flavor or aroma; for example, the post-chromatography composition does not include one or more of the compounds shown in Tables 1-4, or any combination thereof, above the disclosed preferred content levels. The post-chromatography composition can be similar or identical to embodiments of the composition including one or more SGMAs of salts thereof described herein but lacking the steviol glycosides from the separate source added in the method.

The method can include maintaining the pH of the extract below a certain level prior to and/or throughout the chromatographing. Maintaining the pH below a certain level can avoid hydrolyzing the malonic acid esters on the steviol glycoside. The method can include maintaining pH of the extract below (e.g., preventing the pH of the extract from exceeding) 12, 11.5, or 11, preferably below 10.5, 10, 9.5, 9, 8.5, or 8, prior to the chromatographing, throughout the chromatographing, or a combination thereof.

The method can be free of steps that destroy the SGMAs or salts thereof prior to and during the chromatographing, such as treatment with FeCl₃, treatment with Ca(OH)₂, activated carbon treatment, or a combination thereof.

The chromatographing can include chromatographing the extraction solution into a buffered solution that has a pH of 1-9, 1-7, or 1 or more, or both less than 9 and less than, equal to, or greater than 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.8, 4.0, 4.2, 4.4, 4.6, 4.8, 5, 5.5, 6, 6.5, 7, 7.5, 8, or 8.5.

The chromatographing can include any suitable chromatography, such as ion exchange chromatography, adsorption chromatography (e.g., using an adsorption resin), column chromatography, or a combination thereof. The chromatographing can include anionic resin chromatography.

The anionic resin chromatography can include passing the extract through an anionic resin to bind the anionic SGMA species. The chromatography can include washing the column to remove all neutral species (e.g., including traditional SGs), such as with water, a water miscible alcohol such as ethanol or methanol, or a combination thereof, leaving SGMA species behind on the column The chromatography can include washing the column to remove SGMAs therefrom, such as using sodium acetate dissolved in water, a water miscible alcohol such as ethanol or methanol, or a combination thereof.

The method can further include further purifying the SGMA after the chromatographing. The further purification can be any suitable further purification. The further purification can include membrane filtration, ion exchange chromatography, adsorption chromatography (e.g., using an adsorption resin), column chromatography, activated carbon treatment, crystallization, treatment with FeCl₃, treatment with Ca(OH)₂, or a combination thereof.

The method can include further processing the SGMA after the chromatographing. The further processing can be any suitable further processing. The further processing can include decolorizing, evaporating, deionizing, concentrating, drying, or a combination thereof.

### Method of Making a Sweetener or Sweetened Composition.

Various aspects the present invention provide a method of making a sweetener or sweetened composition. The method includes combining an SGMA component with a second component to form the sweetener or sweetened composition. The SGMA component includes at least 50 wt %, at least 60 wt %, at least 70 wt %, or preferably at least 80 wt % of one or more steviol glycoside malonic acid esters (SGMAs) or salts thereof. The second component includes at least one sweetener. The sweetened composition can be a beverage concentrate (e.g., a throw syrup, a water enhancer, or a flavored water enhancer), a sweetened beverage (e.g., tea or a carbonated soft drink), a solid food stuff, a pharmaceutical composition, a nutritional supplement, or a dental composition. In some aspects, the sweetened composition is a beverage or beverage concentrate and the method further comprises dissolving at least a portion of the SGMA component to provide an aqueous solution.

The SGMA component preferably includes at least 80 wt % of one or more steviol glycoside malonic acid esters (SGMAs) or salts thereof, or 80 wt % to 100 wt %, or 90 wt % to 100 wt %, or 95 wt % to 100%, or both greater than 80 wt % and less than, equal to, or greater than 80 wt %, 81, 82, 83, 84, 85, 86, 87, 88, 89, 90, 91, 92, 93, 94, 95, 96, 97, 98, 99, 99.9, or 99.99 wt %.

The second component includes at least one sweetener. The sweetener can be chosen from steviol glycosides, mogrosides, a sugar, aspartame, sucralose, neotame, and brazzein. The sugar can be any suitable sugar, such as at least one chosen from sucrose, glucose, fructose, and psicose. The at least one sweetener is preferably a natural sweetener, and more preferably natural high-intensity sweeteners such as steviol glycosides or mogrosides.

Preferably, the SGMA component is free of or has a limited content of compounds that can adversely impact flavor or aroma. For example, 0-5% (wt) of the SGMA component can be one or more of quercetin, kaempferol, myricetin, fisetin, galangin, isorhamnetin, pachypodol, rhamnazin, pyranoflavonols, furanoflavonols, luteolin, apigenin, tangeritin, taxifolin (or dihydroquercetin), dihydrokaempferol, hesperetin, naringenin, eriodictyol, homoeriodictyol, genistein, daidzein, glycitein, hesperidin, naringin, rutin, quercitrin, luteolin-glucoside, quercetin-xyloside, cyanidin, delphinidin, malvidin, pelargonidin, peonidin, and petunidin; or 0-3% (wt) of the SGMA component can be one or more of malonate, malonic acid, oxalate, oxalic acid, lactate, lactic acid, succinate, succinic acid, malate, malic acid, citrate, and citric acid; or 0-1% (wt) of the SGMA component can be one or more of sulfate, sulfuric acid, phosphate, phosphoric acid, nitrate, nitric acid, nitrite, nitrous acid, chloride, hydrochloric acid, ammonia, ammonium, tannic acid, monoglycerides, diglycerides, triglycerides, glucose, fructose, sucrose, galactose, ribose, trehalose, trehalulose, lactose, maltose, isomaltose, isomaltulose, mannose, tagatose, arabinose, rhamnose, xylose, dextrose, erythrose, threose, maltotriose, panose, glycerol, sorbitol, mannitol, xylitol, maltitol, lactitol, erythritol, isomalt, and inositol; or 0-0.5% (wt) of the SGMA component can be one or more of tartrate, tartaric acid, pyruvate, pyruvic acid, fumarate, fumaric acid, ascorbic acid, sorbate, sorbic acid, acetate, acetic acid, and chlorophyll.

In various aspects, the SGMA component can include less than 0.3% (wt) of malonate, malonic acid, oxalate, oxalic acid, lactate, lactic acid, succinate, succinic acid, malate, or malic acid; or less than 0.05% (wt) of pyruvate, pyruvic acid, fumarate, fumaric acid, tartrate, tartaric acid, sorbate, sorbic acid, acetate, or acetic acid; or less than about 0.05% (wt) of chlorophyll. The SGMA component can be free of malonate, malonic acid, oxalate, oxalic acid, lactate, lactic acid, succinate, succinic acid, malate, and malic acid; or is free of pyruvate, pyruvic acid, fumarate, fumaric acid, tartrate, tartaric acid, sorbate, sorbic acid, acetate, and acetic acid; or can be chlorophyll-free. An amount of less than 0.1 wt % of the SGMA component can be one or more of alanine, arginine, asparagine, aspartic acid, cysteine, glutamine, glutamic acid, glycine, histidine, isoleucine, leucine, lysine, methionine, phenylalanine, proline, serine, threonine, tryptophan, tyrosine, valine, acacia (arabic) gum, agar-agar, algin-alginate, arabynoxylan, beta-glucan, beta mannan, carageenan gum, carob or locust bean gum, fenugreek gum, galactomannans, gellan gum, glucomannan or konjac gum, guar gum, hemicellulose, inulin, karaya gum, pectin, polydextrose, psyllium husk mucilage, resistant starches, tara gum, tragacanth gum, xanthan gum, cellulose, chitin, and chitosan.

### EXAMPLES

Various embodiments of the present invention can be better understood by reference to the following Examples which are offered by way of illustration. The present invention is not limited to the Examples given herein.

### Example 1. Analysis of Stevia Leaf Extract

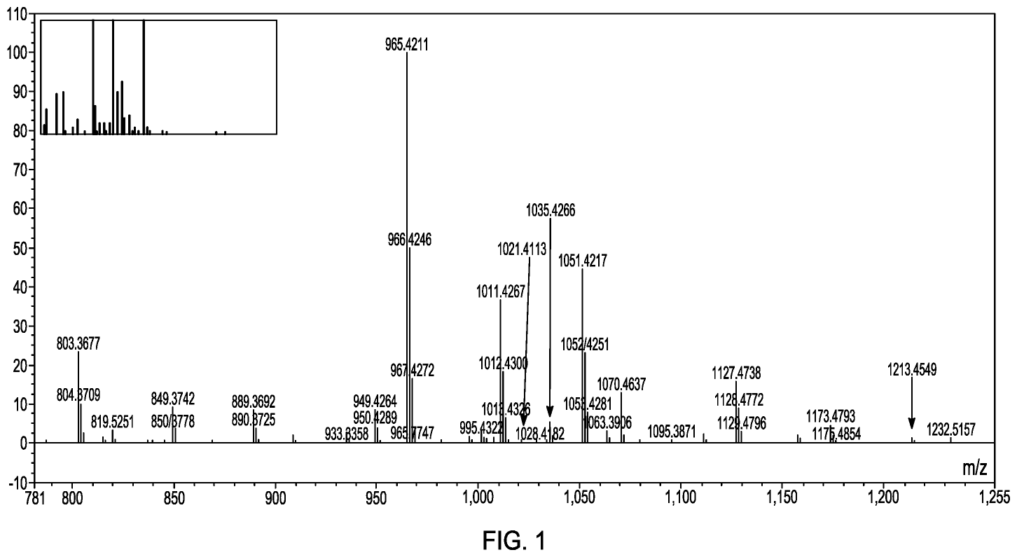

A stevia leaf extract was obtained by mixing 1 g of powdered stevia leaf with 10 mL of aqueous ethanol (50%) on a sample rotator for 30 minutes. The extract was then diluted 1:100 in purified water prior to analysis. FIG. 1 illustrates a mass spectrum of a flow injection analysis (FIA) of the leaf extract.

Key ions corresponding to the novel steviol glycosides (steviol glycoside malonate esters, or SGMAs) are listed in Table 5. Other compounds were seen beyond these, but these five types of compounds were the major novel species.

TABLE 5
Novel steviol glycosides in the stevia leaf extract.

| Compound | Theoretical m/z value, [M−H]⁻ |
|---|---|
| Stev + 2Glc + 1GlcMA | 889.3711 |
| Stev + 3Glc + 1GlcMA | 1051.4239 |
| Stev + 4Glc + 1GlcMA | 1213.4767 |
| Stev + 2Glc + 1GlcMA + 1Rha | 1035.4290 |
| Stev + 2Glc + 1GlcM A + 1Xyl | 1021.4133 |

The abundance of the species in FIG. 1 also reveals that the overall concentration of sugars on steviol glycosides (SGs) in the leaf are in the following order: Glc>>GlcMA Rha>Xyl. SGs with malonated glucose (GlcMA) moieties are highly concentrated in the leaf and in the example above, the second most concentrated SG is Stev+3Glc+1GlcMA (following the most concentrated Stev+4Glc, which is Reb A, Reb E, etc.).

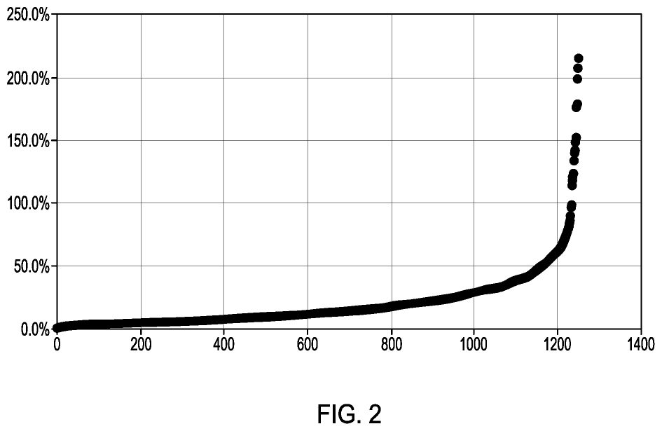

Analysis of over 1,200 stevia samples from a variety of sources showed an average of 19.6% malonated glucose-containing steviol glycosides (SGMA) relative to traditional SG content, where traditional SG content is the sum of all SGs containing either Glc, Rha, and/or Xyl sugar additions. FIG. 2 illustrates the percentage of SGMAs in the stevia leaf extracts, compared to traditional (non-malonated) steviol glycosides. The average SGMA/traditional SGs content was 19.6%, but some were as high as 216% (more SGMAs than traditional SGs). The amount of SGMA in common stevia leaf was >2% on a dry weight basis.

### Example 2. Chromatographic Separation of Stevia Leaf Extract

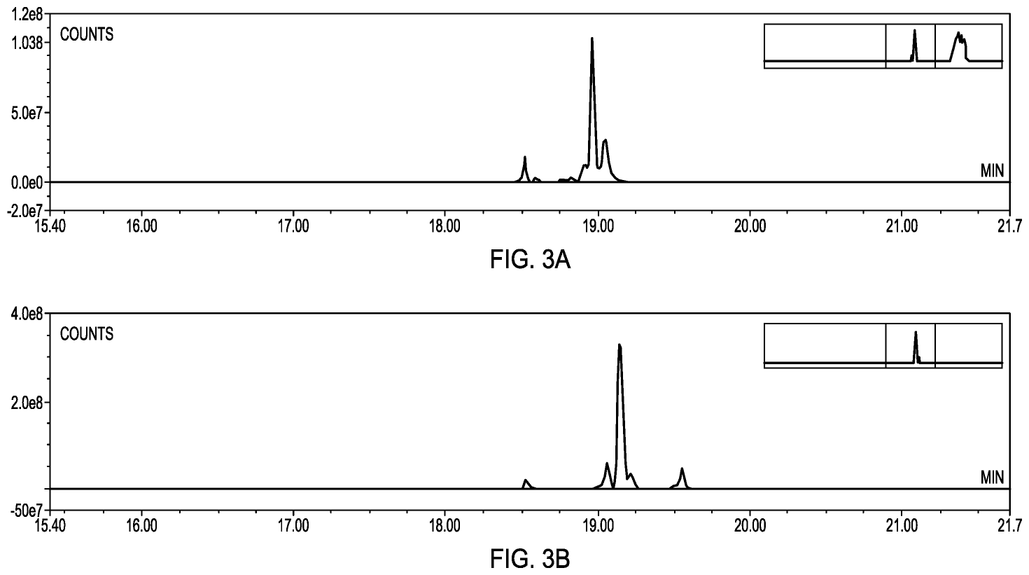

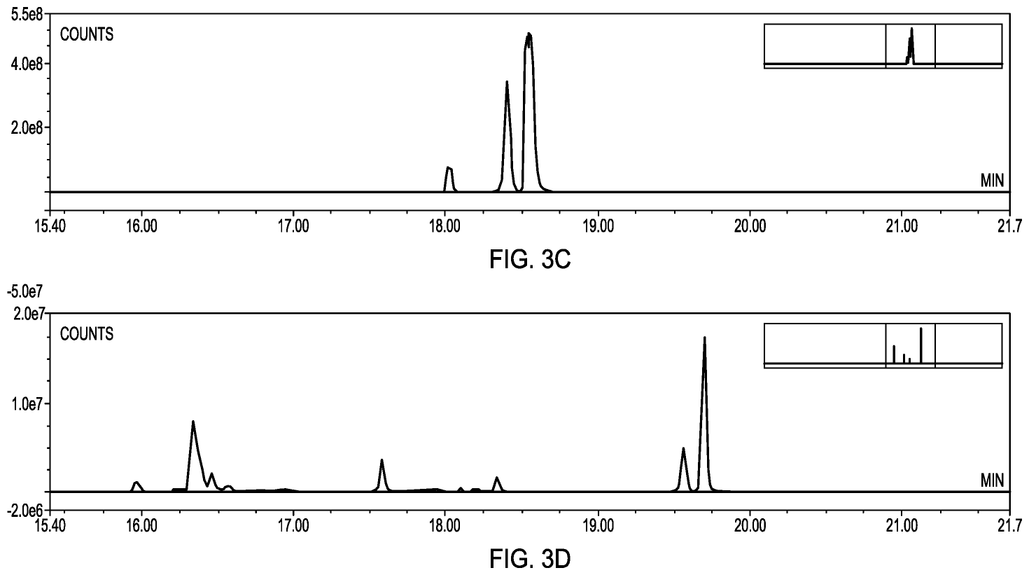

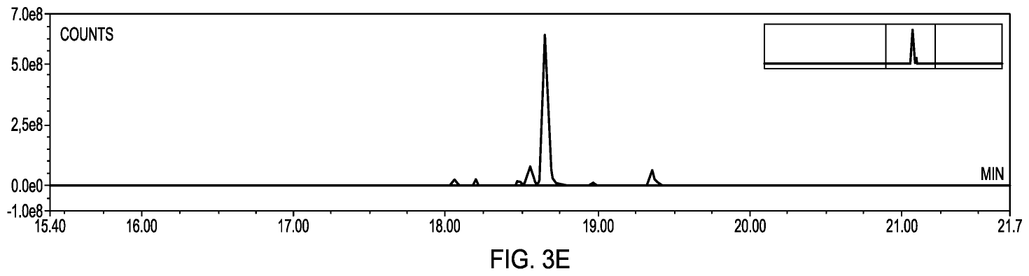

Chromatographic separation was run to determine how many novel SGMA species are present in the leaf. Several different leaf sources were combined into a single extract representative of the diversity observed in the breeding program. The combined material was extracted into 50% (vol/vol) ethanol in water for 1 hour and diluted 1:100 into water for analysis by LC-MS. FIGS. 3a-d, 4a-d, and 5a-d illustrate results of the separation.

Chromatographic separation of the species show several isomers of each major SGMA type: Stev+2Glc+1Xy1+1GlcMA (FIG. 3a) has five major isomers; Stev+2Glc+1Rha+1GlcMA (FIG. 3b) has five major isomers; Stev+3Glc+1GlcMA (FIG. 3c) has four major isomers; Stev+4Glc+1GlcMA (FIG. 3d) has eight major isomers; and Stev+2Glc+1GlcMA (FIG. 3e) has six major isomers. Altogether between these five classes of SGs, there are 28 novel SGs.

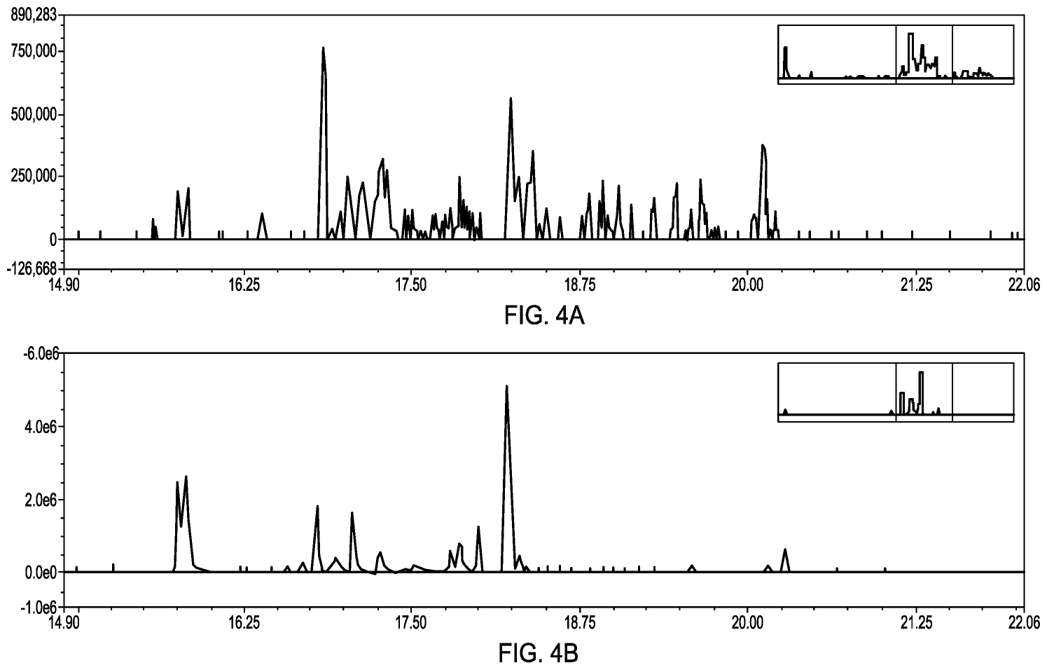

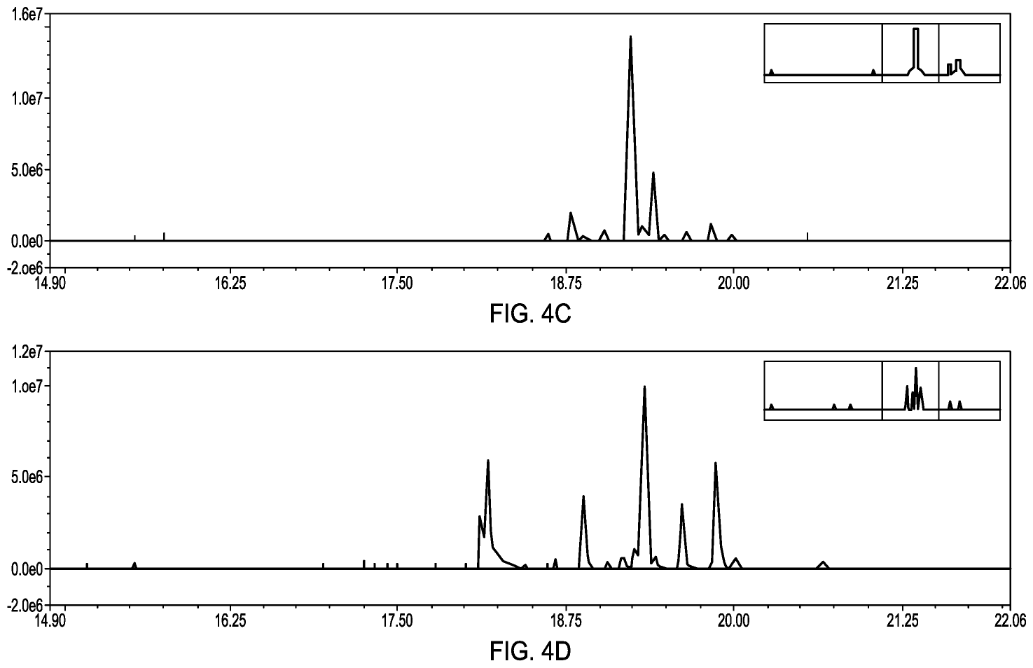

Chromatographic separation of the species show several isomers of minor SGMA type: Stev+3Glc+1GlcMA+1Xyl (FIG. 4a) has three isomers; Stev+3Glc+1GlcMA+1Rha (FIG. 4b) has nine isomers; Stev+1Glc+1GlcMA+1Xyl (FIG. 4c) has six isomers; and Stev+1Glc+1GlcMA+1Rha (FIG. 4d) has seven isomers detected.

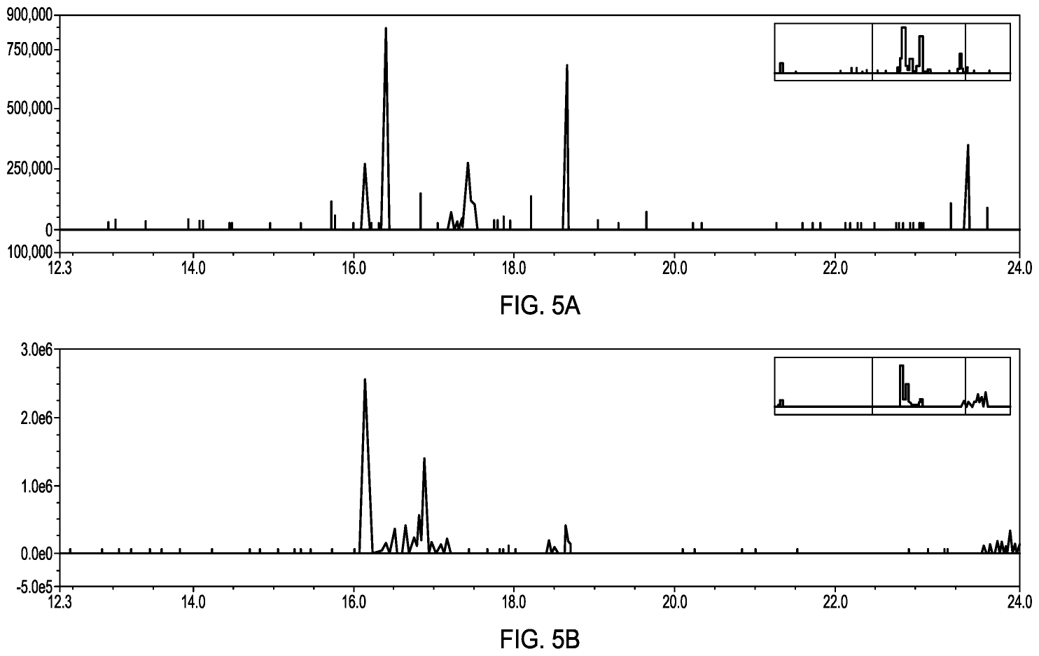

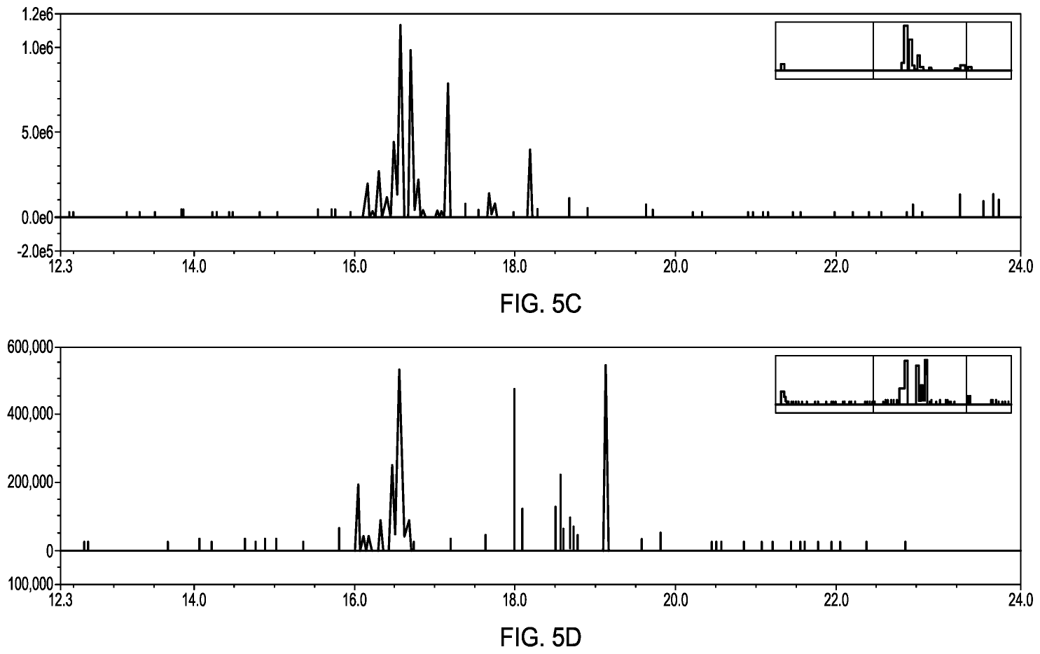

Chromatographic separation of the species show several additional isomers of minor SGMA type: Stev+4Glc+1GlcMA+1Xyl (FIG. 5a) has four isomers; Stev+4Glc+1GlcMA+1Rha (FIG. 5b) has six isomers; Stev+5Glc+1GlcMA (FIG. 5c) has seven isomers; and Stev+5Glc+1GlcMA+1Rha (FIG. 5d) has two isomers; together with the major SGMA species detected in FIGS. 3a-e and the other minor species shown in FIG. 4a-d, there were 72 novel SGMAs in this leaf extract sample.

### Example 3. Elucidation of Structure of Malonated Steviol Glycosides.

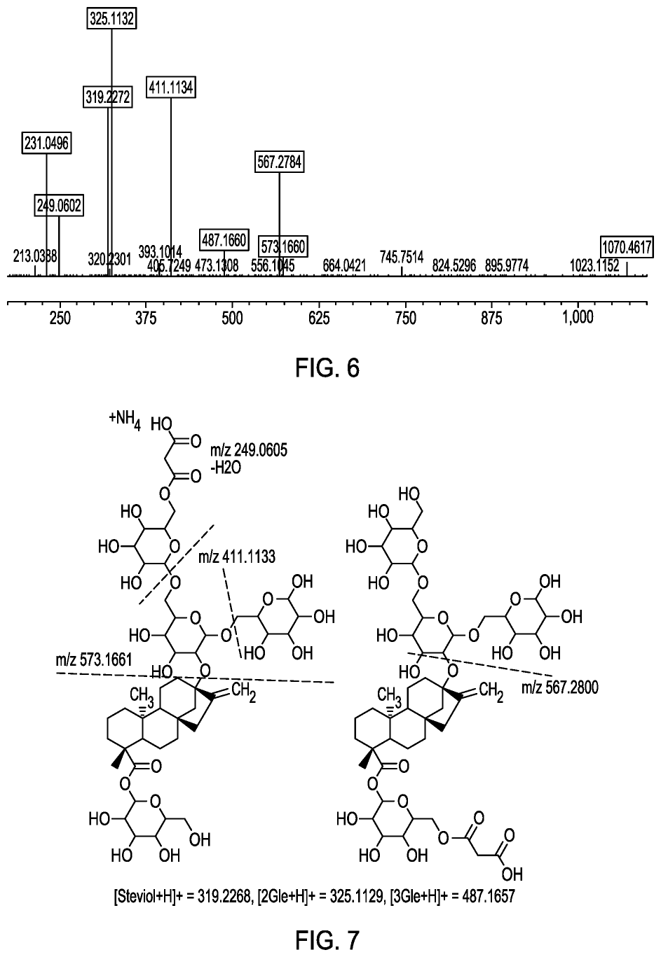

FIA/MS/MS was performed on the stevia leaf extract described in Example 1 to determine the structure of the novel SGs. The MS/MS data is shown in FIG. 6, arising from fragmentation of the m/z value at 965.4211 (isolation width 4 amu). The MS/MS data matches the predicted structures (exact bonding of the sugar moieties is uncertain without high resolution NMR). FIG. 7 shows an explanation for the fragments seen in the mass spectrum shown in FIG. 6, illustrating how the different sugar moieties are fragmented to characterize the molecule. Two different isomers are presented in FIG. 7. On the left, the GlcMA is substituted on the 13-carbon yielding many of the MS/MS fragments detected (m/z values denoted are theoretical). On the right, the GlcMA is substituted on the 19 carbon, yielding the remainder of the MS/MS fragments detected.

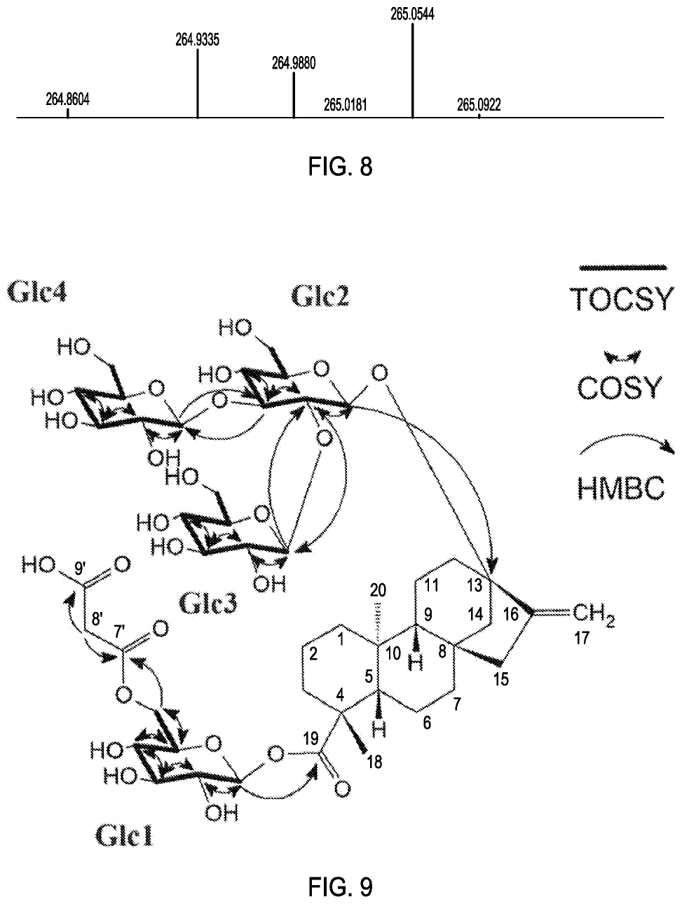

If GlcMA is substituted to SGs, then it stands to reason that there should be some unbound GlcMA in the leaf extract. The free GlcMA was searched for and found in the stevia leaf extract as illustrated in the mass spectrum shown in FIG. 8, which is zoomed around the GlcMA ion. Theoretical [M-H]- for free GlcMA is 265.0565.

### Example 4. Isolation and Characterization of Five Malonated Steviol Glycosides

Five different malonated steviol glycosides were isolated and characterized. After crude purification, the SGMA fraction was further purified via preparative-scale chromatography (PrepLC). The materials were purified utilizing Phenomenex Kinetex XB-C18 5 μm stationary phase and a 0.2% acetic acid and methanol gradient. To purify to individual components at a high enough level for NMR analysis (-90% or greater), an iterative approach was taken to fraction collection, heartcutting the peaks of interest to get the highest purity fractions. Typically 3-5 iterations were needed to obtain high enough purity material.

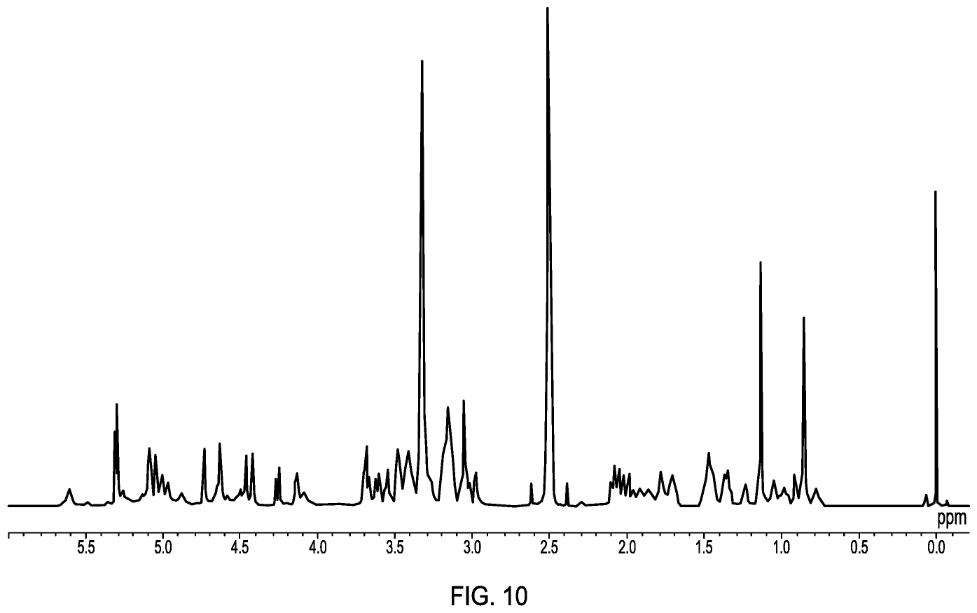

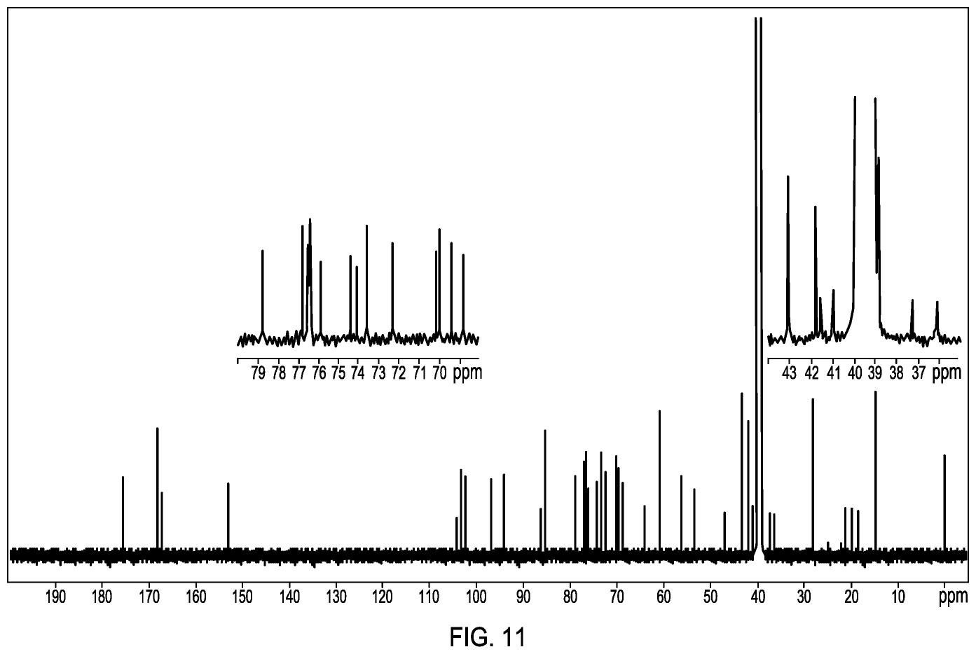

FIG. 9 illustrates an isolated malonated steviol glycoside similar to Rebaudioside A, showing 2D-NMR evidence for various connectivity. FIG. 10 illustrates the ¹H NMR spectrum for this compound and FIG. 11 illustrates the ¹³C spectrum.

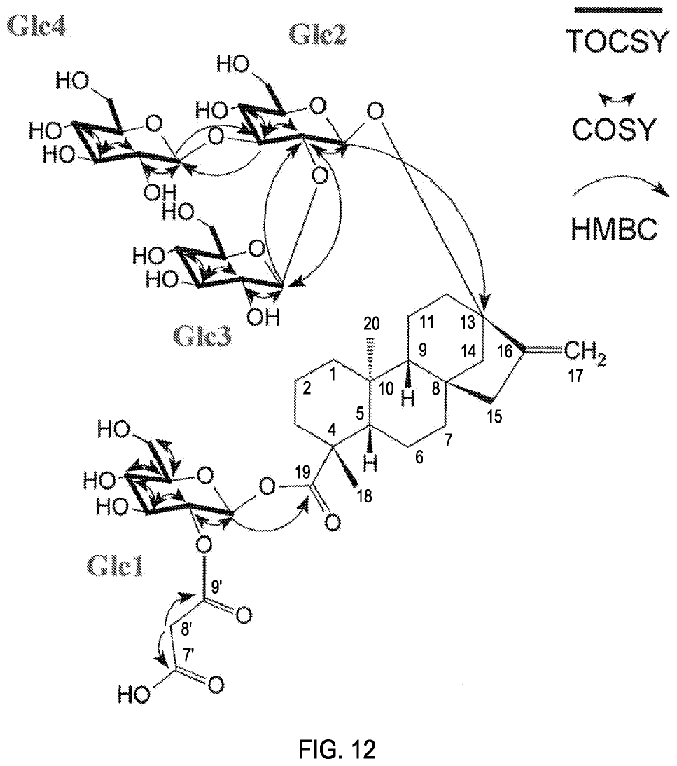

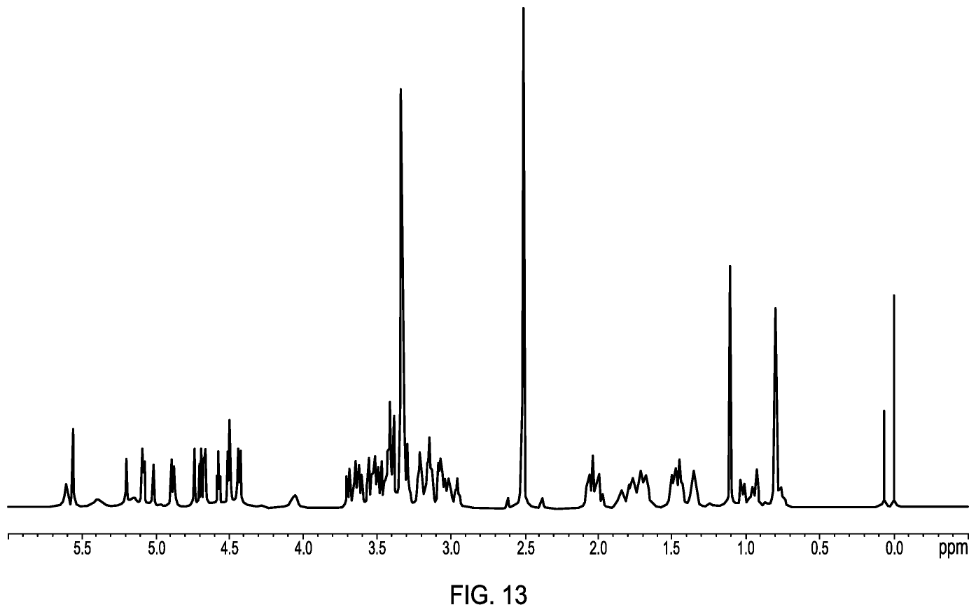

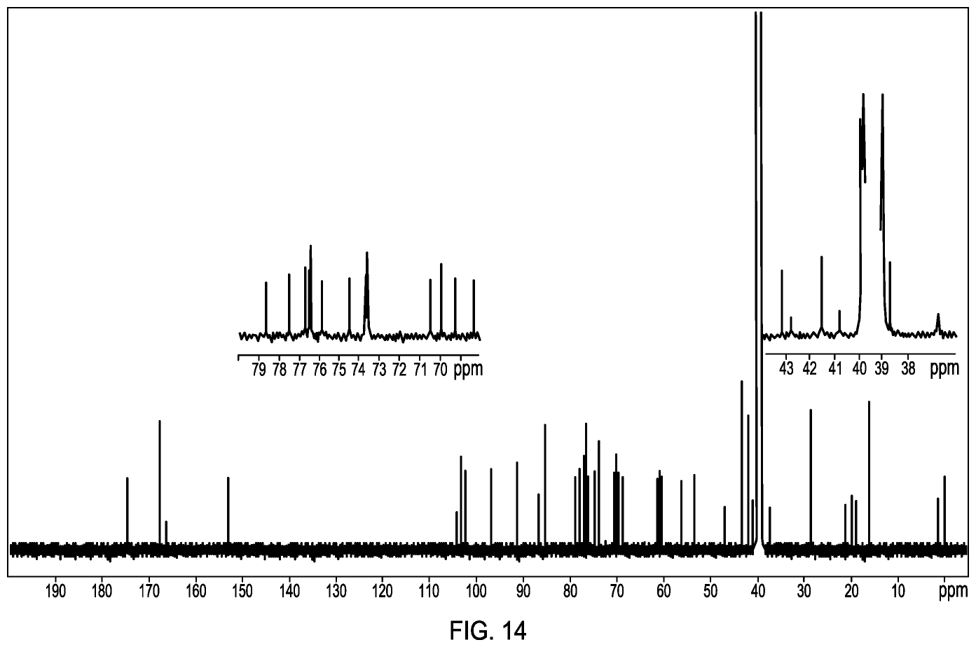

FIG. 12 illustrates an isolated malonated steviol glycoside similar to Rebaudioside A, showing 2D-NMR evidence for various connectivity. FIG. 13 illustrates the ¹H NMR spectrum for this compound and FIG. 14 illustrates the ¹³C spectrum.

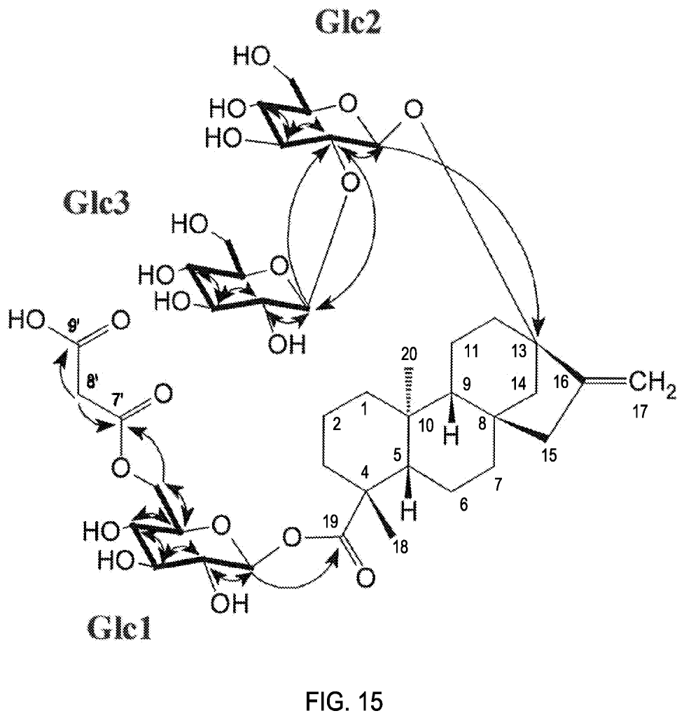

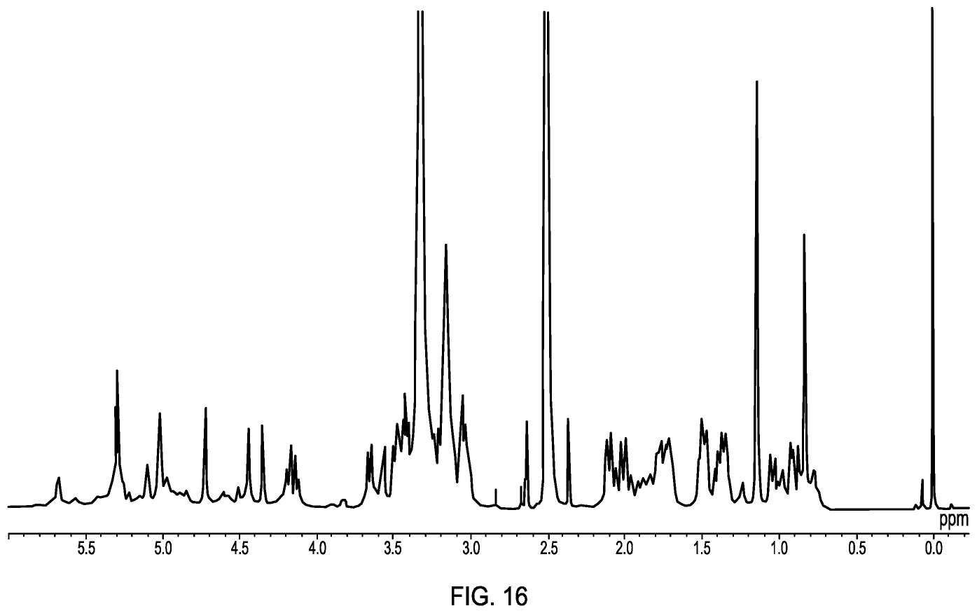

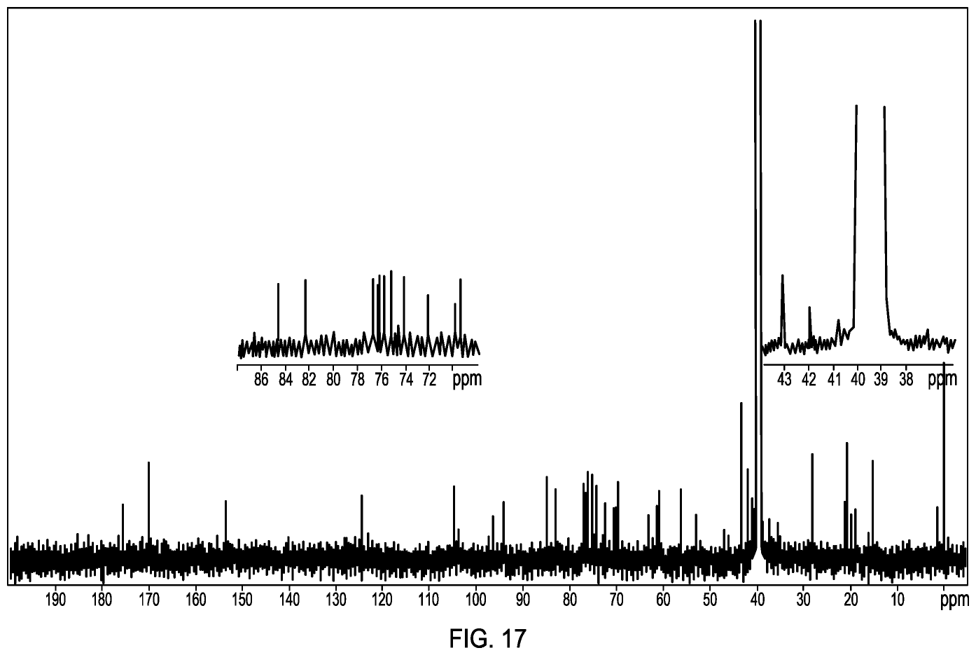

FIG. 15 illustrates an isolated malonated steviol glycoside similar to stevioside, showing 2D-NMR evidence for various connectivity. FIG. 16 illustrates the ¹H NMR spectrum for this compound and FIG. 17 illustrates the ¹³C spectrum.

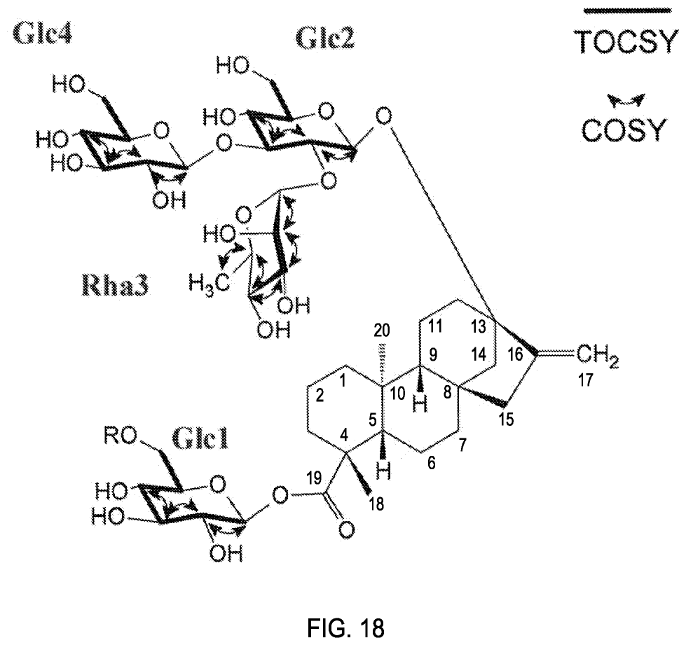

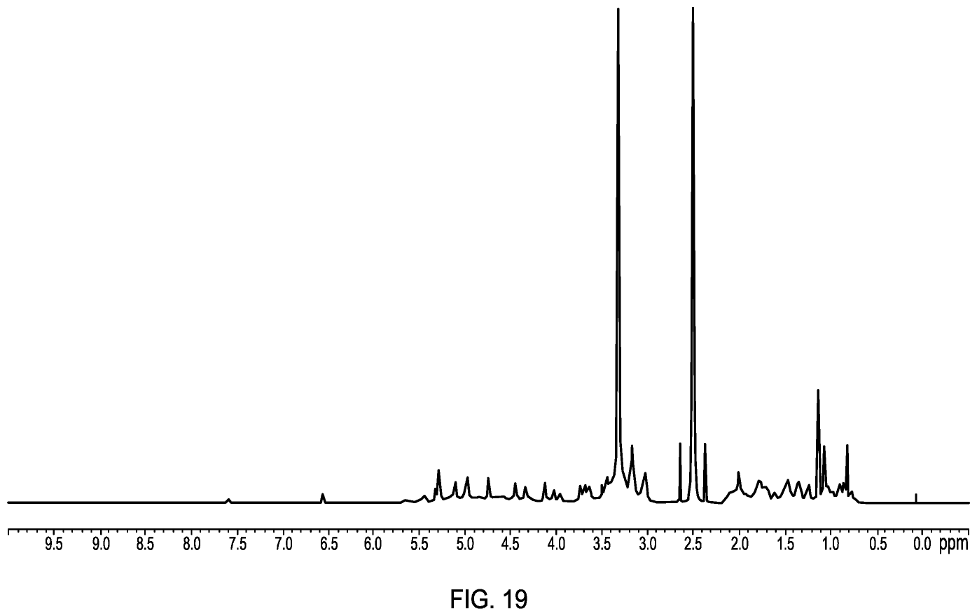

FIG. 18 illustrates an isolated malonated steviol glycoside similar to Rebaudioside C, showing 2D-NMR evidence for various connectivity. FIG. 19 illustrates the ¹H NMR spectrum for this compound.

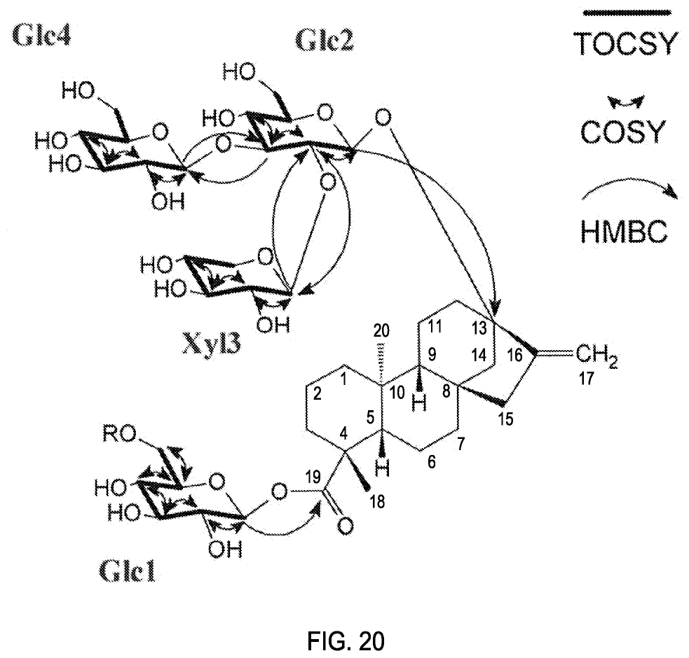

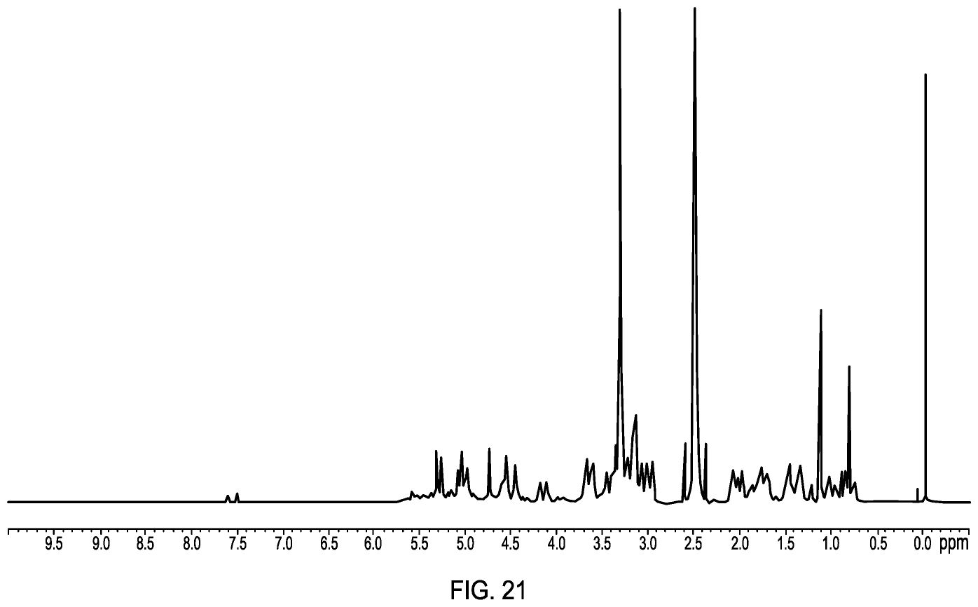

FIG. 20 illustrates an isolated malonated steviol glycoside similar to Rebaudioside F, showing 2D-NMR evidence for various connectivity. FIG. 21 illustrates the ¹H NMR spectrum for this compound.

### Example 5. Malonated Steviol Glycoside pH Stability

A semi-purified mixture of SGMA compounds was obtained by taking powdered dry stevia leaf (160 g) and extracting with 50% vol/vol ethanol in water (1600 mL) for 60 min with occasional stirring. The solid plant matter was removed via filtration through a Buchner funnel and Whatman 54 filter paper. The residual plant mass was washed with an additional volume of 50% vol/vol ethanol in water (800 mL). The initial extract was treated with ethyl acetate (1:1 extraction volume) to remove hydrophobic colored bodies and any residual ethyl acetate was allowed to evaporate under a stream of nitrogen. The clarified extract was then passed through an anionic resin (Dowex 66) to bind the ionic SGMA species. The resin was washed with aqueous ethanol (50%) to remove all neutral species, including traditional SGs. The SGMAs were then eluted with aqueous ethanol (50%) containing 5% sodium acetate. The eluent was collected and dried to remove excess ethanol. Once <10% ethanol remained, the eluent was acidified with HCl to pH 1-2 and was desalted on a hydrophobic resin (Diaion Sepabeads SP70) by loading directly, followed by washing with 15% vol/vol ethanol and eluting with 70% ethanol. The desalted eluent was then dried under nitrogen to remove the ethanol and lyophilized to complete dryness. The SGMA compounds were exposed to strong acid and strong base in water to determine chemical stability. The SGMAs were more stable to acidic conditions (pH ˜1, >6 h), but degrade quickly (<10 min) at room temperature under strongly basic conditions (pH>13).

### Example 6. Effect of Current Stevia Leaf Processing Conditions

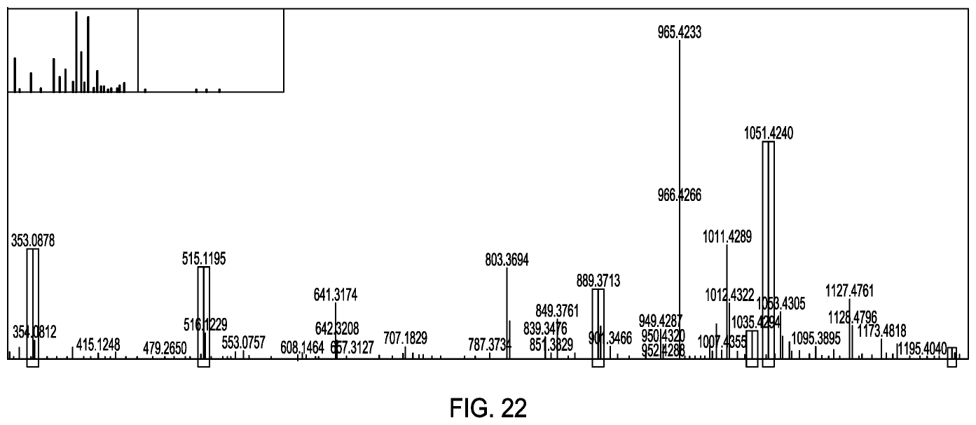

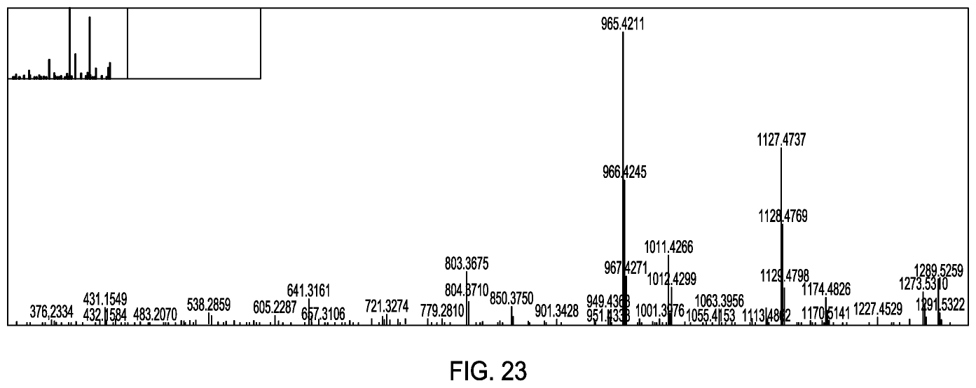

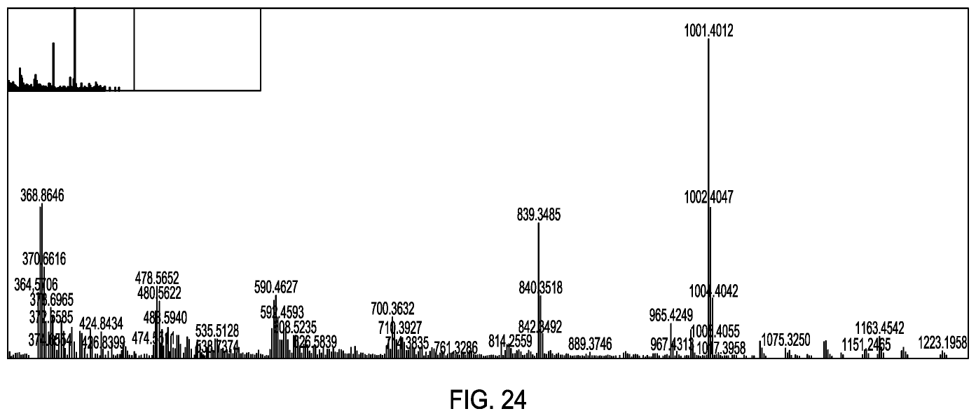

Stevia leaf extract (extracted with water only) was also treated with a weak anion exchange resin and iron(III) chloride to mimic two steps of current stevia leaf processing conditions. FIGS. 22, 23, and 24 illustrate FIA spectra illustrating the effect of conventional processing conditions on SGMAs. FIG. 22 illustrates an FIA spectrum of aqueous stevia leaf extract before treatment. SGMA compounds are circled. Monocaffeoylquinic acids (MCQAs) and dicaffeoylquinic acids (DCQAs) are also circled. Before treatment, significant levels of SGMAs, MCQAs, and DCQAs are present. FIG. 23 illustrates an FIA spectrum after anionic resin treatment. All SGMA and quinic acid compounds were completely removed. FIG. 24 illustrates an FIA spectrum after iron(III) chloride treatment and filtration. All SGMA and quinic acid compounds are completely removed. Many iron salt species detected (clusters of ions around 350-750 m/z). SGs are mainly ionized as formic acid adducts under this experiment's conditions, i.e. 839.3485=Stev+3Glc (stevioside/Reb B) and 1001.4012=Stev+4Glc (Reb A/Reb E).

### Example 7. Sensory Characteristics of Malonated Steviol Glycosides

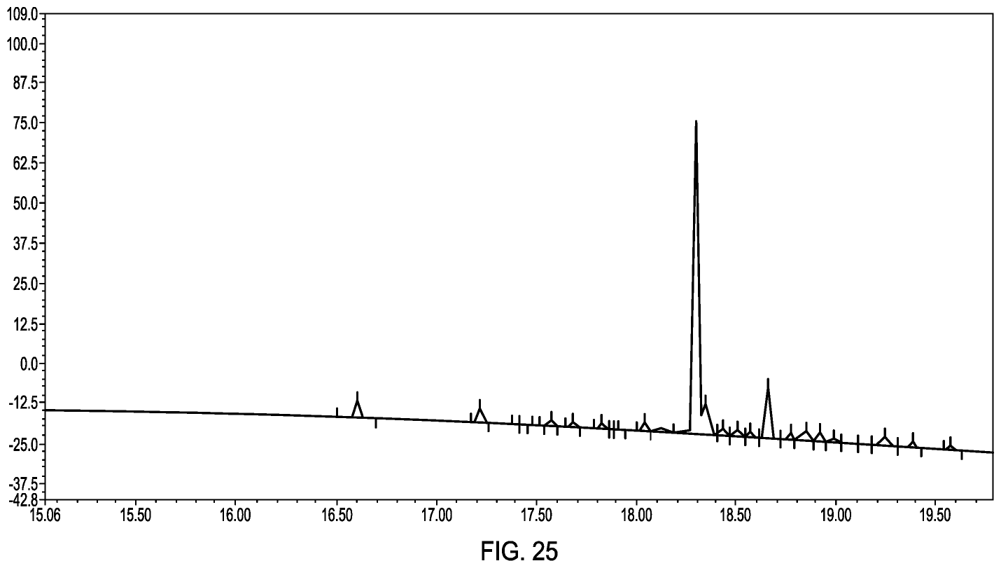

A semi-purified mixture of SGMA compounds was obtained by the same procedure given in Example 5. A solution was made in water at 300 ppm “as is” and tasted compared to RA95 and RM80 (i.e., SGs with equal to or greater than 96% rebaudioside A, and SGs with about 80-85 wt % rebaudioside M, respectively) at similar concentrations. FIG. 25 illustrates an UHPLC/UV chromatogram for the solution, showing that >90% SGMA compounds were present with the majority being Stev+3Glc+1GlcMA isomers.

Three trained taste testers tasted the solutions and found similar results. Sweetness linger of SGMAs was significantly reduced as compared to RM80 and RA95. The SGMA material had a clean sweetness. One analyst thought the SGMA sweetness had a “spiky” quality to it (early onset). Overall sweetness intensity of the SGMA blend was similar to RM80.

### Example 8. Sensory Evaluation of a Chocolate Milk Beverage Sweetened with Malonated Steviol Glycosides

Four chocolate milk beverages were prepared for study, one of which was sweetened with rebaudioside A (RA80) and the other three of which were sweetened with varying concentrations of SMGAs. The RA80 (i.e., SGs with about 80-85 wt % rebaudioside A) product was prepared by adding all dry ingredients to the 1% milk and mixing with a high-shear mixer at 6,000 rpm for approximately 5 minutes until all material was dissolved and homogeneous, using the formulation shown in Table 6. For the three SGMA products, first an unsweetened milk base of the ingredients in Table 6 without the stevia was prepared in the same fashion. Then, aliquots of this base were removed and appropriate amounts of SGMA material were added to achieve desired concentrations, as shown in Table 7.

TABLE 6
Chocolate milk formulations.

| Ingredient Description | % Wt | Grams |
|---|---|---|
| Low Fat (1%) Milk | 99.057% | 990.5650 |
| Stevia (RA80) | 0.0235% | 0.2350 |
| Carageenan | 0.0250% | 0.2500 |
| Corn Starch | 0.330% | 3.3000 |
| Cocoa Powder | 0.458% | 4.5800 |
| Salt | 0.087% | 0.8700 |
| Vanillin | 0.005% | 0.0500 |
| TOTALS | 100.000% | 1000.00 |

TABLE 7
Sweetener concentrations.

| | SG Material | Concentration |
|---|---|---|
| Sample 1 | RA80 | 235 ppm |
| Sample 2 | Mixed SGMA | 235 ppm |
| Sample 3 | Mixed SGMA | 300 ppm |
| Sample 4 | Mixed SGMA | 350 m |

The “Mixed SGMA” material was the same as the material isolated in Example 5. At the time of this sample preparation, the material had degraded such that 78% (wt/wt) of the total mass was novel SGMA species (60% wt/total wt was a reb A analog, 13% wt/total wt was a stevioside analog, and the remainder were other SGMA species). Reb A and stevioside accounted for 17% wt/wt and 4% wt/wt, respectively, of the mass of the Mixed SGMA powder.

A group of three trained taste testers tasted the four samples and made comments regarding total sweetness, sweetness quality, sweetness linger, bitterness, and other off-flavors. Samples were freely available and the participants tasted the samples several times in any order for comparison. Sensory notes are shown in Table 8.

TABLE 8
Sensory notes on chocolate milk samples.

| | Sensory Notes |
|---|---|
| Sample 1 | Typical SG off-notes: slight bitterness, and mild sweet linger. |
| Sample 2 | Slightly less total sweetness than Sample 1. Noticeably less sweet linger. |
| | Less upfront bitterness and characteristic Reb A off-notes than Sample 1. |
| Sample 3 | Close in sweetness to Sample 1. Noticeably less linger and less |
| | bitterness/off-notes. Faint botanical notes. |
| Sample 4 | More total sweetness than Sample 1. Mild botanical or plant-like off- |
| | notes. Still less sweet linger and less bitterness than Sample 1. |

The tested SGMA compounds provided sweetness in beverage applications. They were slightly less sweet than their corresponding traditional glycosides (primarily Reb A and stevioside) and also had less off-notes, bitterness, and sweet linger than traditional glycosides.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present invention. Thus, it should be understood that although the present invention has been specifically disclosed by specific embodiments and optional features, modification and variation of the concepts herein disclosed may be resorted to by those of ordinary skill in the art, and that such modifications and variations are considered to be within the scope of embodiments of the present invention.

### Exemplary Embodiments

The following exemplary embodiments are provided, the numbering of which is not to be construed as designating levels of importance:

Embodiment 1 provides a steviol glycoside malonic acid ester (SGMA) or salt thereof.

Embodiment 2 provides the SGMA of Embodiment 1, wherein the malonic acid ester group has the structure:

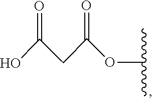 [SMILES: *OC(=O)CC(=O)O]

or a salt thereof.

Embodiment 3 provides the SGMA of any one of Embodiments 1-2, wherein the SGMA comprises one or more of glucose, xylose, rhamnose, or a combination thereof.

Embodiment 4 provides the SGMA of any one of Embodiments 1-3, wherein the SGMA has 1 to 3 malonic acid ester groups.

Embodiment 5 provides the SGMA of any one of Embodiments 1-4, wherein the SGMA has 1 malonic acid ester group.

Embodiment 6 provides the SGMA of any one of Embodiments 1-5, wherein the salt is a malonic acid salt comprising a counterion that is sodium, potassium, calcium, magnesium, ammonium, or a combination thereof.

Embodiment 7 provides the SGMA of any one of Embodiments 1-6, wherein the salt is a malonic acid salt comprising a counterion that is sodium, potassium, or a combination thereof.

Embodiment 8 provides the SGMA of any one of Embodiments 1-7, wherein the SGMA has the structure:

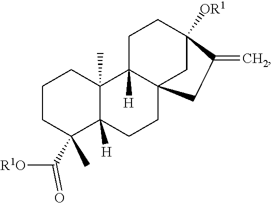

or a salt thereof;

wherein

at each occurrence R¹ is independently chosen from —H, a malonic acid ester or a salt thereof, and a glycosidically-bonded primary sugar,

at each occurrence the primary sugar is independently chosen from glucose, xylose, and rhamnose, and at each occurrence the primary sugar independently optionally comprises a secondary sugar glycosidically-bonded to the primary sugar, a malonic acid ester or a salt thereof bonded to the primary sugar, or a combination thereof,

at each occurrence the secondary sugar, if present, is independently chosen from glucose, xylose, and rhamnose, and at each occurrence the secondary sugar independently optionally comprises a tertiary sugar glycosidically-bonded to the secondary sugar, a malonic acid ester or a salt thereof bonded to the secondary sugar, or a combination thereof,

at each occurrence the tertiary sugar, if present, is independently chosen from glucose, xylose, and rhamnose, and at each occurrence the tertiary sugar independently optionally comprises a malonic acid ester or a salt thereof bonded to the tertiary sugar, and

the SGMA comprises at least one of the primary sugars and at least one of the malonic acid ester groups or a salt thereof.

Embodiment 9 provides the SGMA of Embodiment 8, wherein the SGMA comprises at least one of the secondary sugars.

Embodiment 10 provides the SGMA of any one of Embodiments 8-9, wherein the SMGA comprises at least one of the tertiary sugars.

Embodiment 11 provides the SGMA of any one of Embodiments 1-10, wherein the SGMA has the structure:

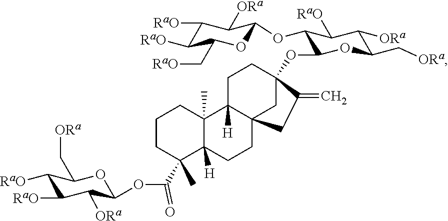

or a salt thereof;

wherein

at each occurrence R^{a} is independently chosen from —H, a malonic acid ester or a salt thereof, and a sugar,

at each occurrence the sugar is independently chosen from glucose, xylose, and rhamnose,

at each occurrence the sugar independently optionally comprises a malonic acid ester or a salt thereof bonded to the sugar, and

the SGMA includes at least one malonic acid ester or a salt thereof.

Embodiment 12 provides the SGMA of Embodiment 11, wherein at each occurrence R^{a} is independently chosen from —H and a malonic acid ester or a salt thereof.

Embodiment 13 provides the SGMA of any one of Embodiments 11-12, wherein the SGMA has the structure:

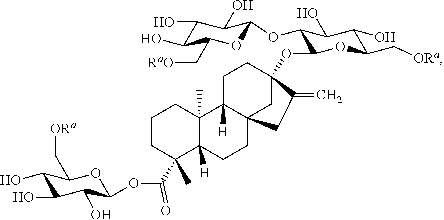

or a salt thereof.

Embodiment 14 provides the SGMA of any one of Embodiments 11-13, wherein the SGMA has the structure:

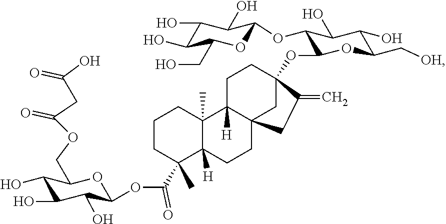

or a salt thereof.

Embodiment 15 provides the SGMA of any one of Embodiments 1-10, wherein the SGMA has the structure:

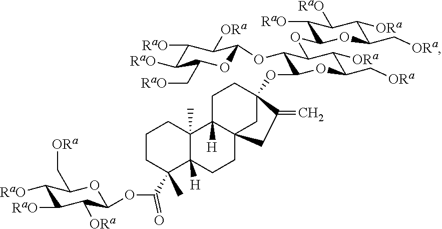

or a salt thereof;

wherein

at each occurrence R^{a} is independently chosen from —H, a malonic acid ester or a salt thereof, and a sugar,

at each occurrence the sugar is independently chosen from glucose, xylose, and rhamnose,

at each occurrence the sugar independently optionally comprises a malonic acid ester or a salt thereof bonded to the sugar, and

the SGMA includes at least one malonic acid ester or a salt thereof.

Embodiment 16 provides the SGMA of Embodiment 15, wherein at each occurrence R^{a} is independently chosen from —H and a malonic acid ester or a salt thereof.

Embodiment 17 provides the SGMA of any one of Embodiments 15-16, wherein the SGMA has the structure:

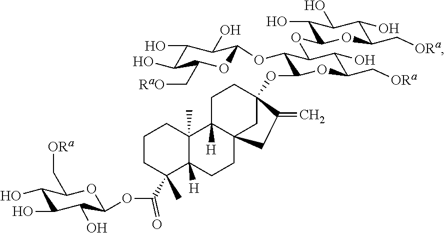

or a salt thereof.

Embodiment 18 provides the SGMA of any one of Embodiments 15-17, wherein the SGMA has the structure:

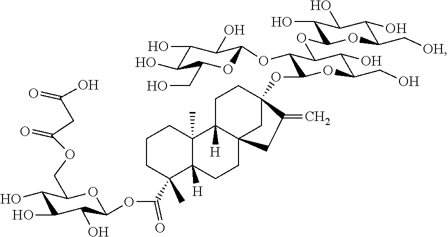

or a salt thereof.

Embodiment 19 provides the SGMA of any one of Embodiments 15-16, wherein the SGMA has the structure:

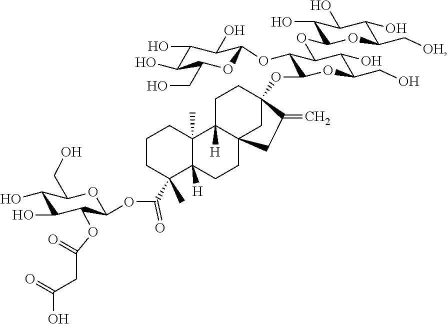

or a salt thereof.

Embodiment 20 provides the SGMA of any one of Embodiments 1-10, wherein the SGMA has the structure:

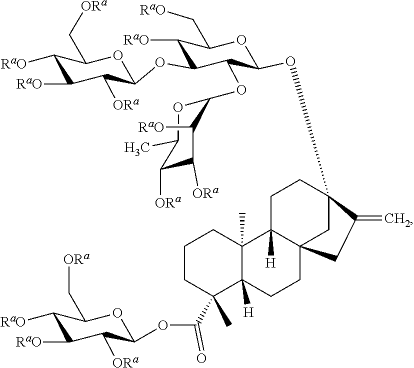

or a salt thereof;

wherein

at each occurrence R^{a} is independently chosen from —H, a malonic acid ester or a salt thereof, and a sugar,

at each occurrence the sugar is independently chosen from glucose, xylose, and rhamnose, and

at each occurrence the sugar independently optionally comprises a malonic acid ester or a salt thereof bonded to the sugar, and

the SGMA includes at least one malonic acid ester or a salt thereof.

Embodiment 21 provides the SGMA of Embodiment 20, wherein at each occurrence R^{a} is independently chosen from —H and a malonic acid ester or a salt thereof.

Embodiment 22 provides the SGMA of any one of Embodiments 20-21, wherein the SGMA has the structure:

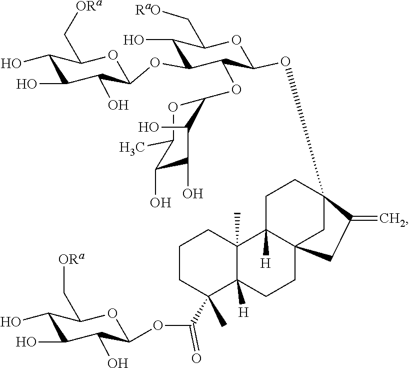

or a salt thereof.

Embodiment 23 provides the SGMA of any one of Embodiments 20-22, wherein the SGMA has the structure:

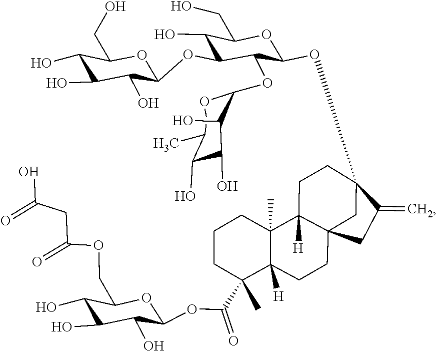

or a salt thereof.

Embodiment 24 provides the SGMA of any one of Embodiments 1-10, wherein the SGMA has the structure:

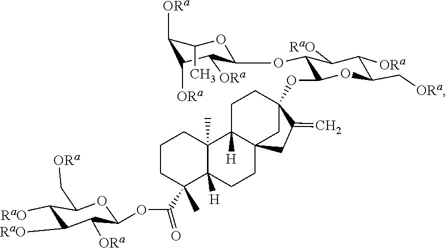

or a salt thereof;

wherein

at each occurrence R^{a} is independently chosen from —H, a malonic acid ester or a salt thereof, and a sugar,

at each occurrence the sugar is independently chosen from glucose, xylose, and rhamnose,

at each occurrence the sugar independently optionally comprises a malonic acid ester or a salt thereof bonded to the sugar, and

the SGMA includes at least one malonic acid ester or a salt thereof.

Embodiment 25 provides the SGMA of Embodiment 24, wherein at each occurrence R^{a} is independently chosen from —H and a malonic acid ester or a salt thereof.

Embodiment 26 provides the SGMA of any one of Embodiments 24-25, wherein the SGMA has the structure:

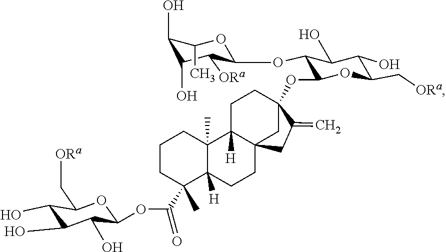

or a salt thereof.

Embodiment 27 provides the SGMA of any one of Embodiments 1-10, wherein the SGMA has the structure:

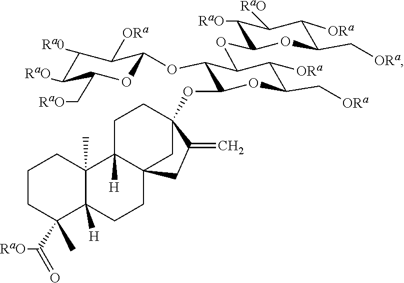

or a salt thereof;

wherein

at each occurrence R^{a} is independently chosen from —H, a malonic acid ester or a salt thereof, and a sugar,

at each occurrence the sugar is independently chosen from glucose, xylose, and rhamnose,

at each occurrence the sugar independently optionally comprises a malonic acid ester or a salt thereof bonded to the sugar, and

the SGMA includes at least one malonic acid ester or a salt thereof.

Embodiment 28 provides the SGMA of Embodiment 27, wherein at each occurrence R^{a} is independently chosen from —H and a malonic acid ester or a salt thereof.

Embodiment 29 provides the SGMA of any one of Embodiments 27-28, wherein the SGMA has the structure:

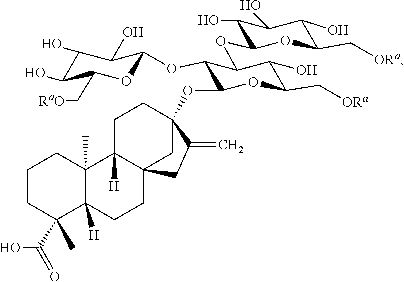

or a salt thereof.

Embodiment 30 provides the SGMA of any one of Embodiments 1-10, wherein the SGMA has the structure:

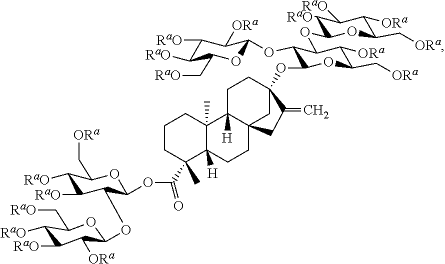

or a salt thereof;

wherein

at each occurrence R^{a} is independently chosen from —H, a malonic acid ester or a salt thereof, and a sugar,

at each occurrence the sugar is independently chosen from glucose, xylose, and rhamnose,

at each occurrence the sugar independently optionally comprises a malonic acid ester or a salt thereof bonded to the sugar, and

the SGMA includes at least one malonic acid ester or a salt thereof.

Embodiment 31 provides the SGMA of Embodiment 30, wherein at each occurrence R^{a} is independently chosen from —H and a malonic acid ester or a salt thereof.

Embodiment 32 provides the SGMA of any one of Embodiments 30-31, wherein the SGMA has the structure:

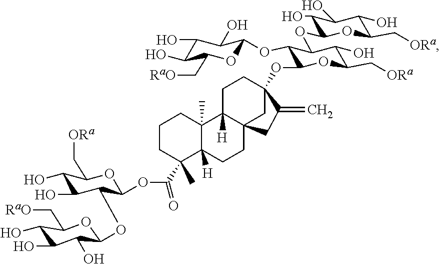

or a salt thereof.

Embodiment 33 provides the SGMA of any one of Embodiments 1-10, wherein the SGMA has the structure:

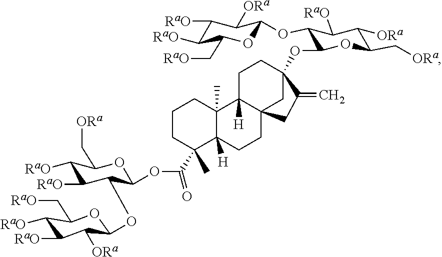

or a salt thereof;

wherein

at each occurrence R^{a} is independently chosen from —H, a malonic acid ester or a salt thereof, and a sugar,

at each occurrence the sugar is independently chosen from glucose, xylose, and rhamnose,

at each occurrence the sugar independently optionally comprises a malonic acid ester or a salt thereof bonded to the sugar, and

the SGMA includes at least one malonic acid ester or a salt thereof.

Embodiment 34 provides the SGMA of Embodiment 33, wherein at each occurrence R^{a} is independently chosen from —H and a malonic acid ester or a salt thereof.

Embodiment 35 provides the SGMA of any one of Embodiments 33-34, wherein the SGMA has the structure:

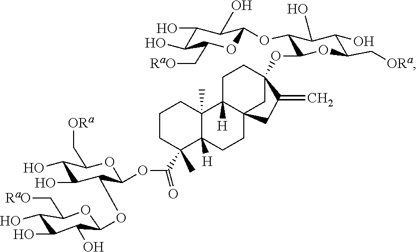

or a salt thereof.

Embodiment 36 provides the SGMA of any one of Embodiments 1-10, wherein the SGMA has the structure:

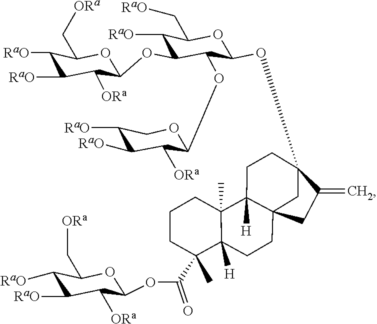

or a salt thereof;

wherein

at each occurrence R^{a} is independently chosen from —H, a malonic acid ester or a salt thereof, and a sugar,

at each occurrence the sugar is independently chosen from glucose, xylose, and rhamnose,

at each occurrence the sugar independently optionally comprises a malonic acid ester or a salt thereof bonded to the sugar, and

the SGMA includes at least one malonic acid ester or a salt thereof.

Embodiment 37 provides the SGMA of Embodiment 36, wherein at each occurrence R^{a} is independently chosen from —H and a malonic acid ester or a salt thereof.

Embodiment 38 provides the SGMA of any one of Embodiments 36-37, wherein the SGMA has the structure:

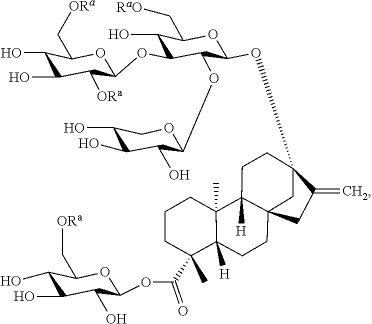

or a salt thereof.

Embodiment 39 provides the SGMA of any one of Embodiments 36-38, wherein the SGMA has the structure:

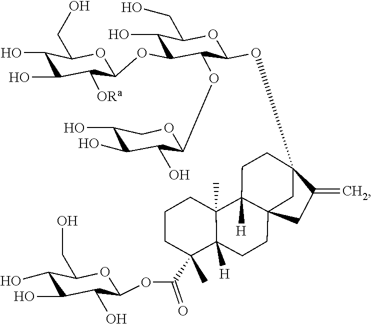

or a salt thereof.

Embodiment 40 provides the SGMA of any one of Embodiments 1-39, wherein the SGMA has a water solubility of at least 40 wt %.

Embodiment 41 provides the SGMA of any one of Embodiments 1-39, wherein the SGMA has a water solubility of 0 wt % to 40 wt %.

Embodiment 42 provides a composition comprising one or more of the SGMAs, salts thereof, or a combination thereof, of any one of Embodiments 1-41.

Embodiment 43 provides the composition of Embodiment 42, wherein the one or more SGMAs, salts thereof, or the combination thereof are 0.001 wt % to 100 wt % of the composition.

Embodiment 44 provides the composition of any one of Embodiments 42-43, wherein the one or more SGMAs, salts thereof, or the combination thereof are 5 wt % to 100 wt % of the composition.

Embodiment 45 provides the composition of any one of Embodiments 42-44, wherein the one or more SGMAs, salts thereof, or the combination thereof are 10 wt % to 100 wt % of the composition.

Embodiment 46 provides the composition of any one of Embodiments 42-45, wherein the one or more SGMAs, salts thereof, or the combination thereof are 0.1 wt % to 90 wt % of the composition.

Embodiment 47 provides the composition of any one of Embodiments 42-46, wherein the one or more SGMAs, salts thereof, or the combination thereof are 0.1 wt % to 30 wt % of the composition.

Embodiment 48 provides the composition of any one of Embodiments 42-47, wherein the composition is substantially free of steviol glycoside stabilizers, wherein the composition has a pH of about 4-9.

Embodiment 49 provides the composition of any one of Embodiments 42-48, wherein the composition is substantially free of organic acid, citric acid, malic acid, phosphate, sulfate, colored bodies, chlorophyll, flavonoids, rutin, quercetin, quercitrin, glucose, fructose, amino acids, proteins, MCQAs, DCQAs, or a combination thereof.

Embodiment 50 provides the composition of any one of Embodiments 42-49, wherein the composition is substantially free of stevia plant matter that is not soluble in water, ethanol, or methanol.

Embodiment 51 provides the composition of any one of Embodiments 42-50, wherein the composition has a concentration of the one or more SGMAs, salts thereof, or combination thereof of 100 ppm to 500,000 ppm.

Embodiment 52 provides the composition of any one of Embodiments 42-51, wherein the composition has a concentration of the one or more SGMAs, salts thereof, or combination thereof of 100 ppm to 2,000 ppm.

Embodiment 53 provides the composition of any one of Embodiments 42-52, wherein the composition has a concentration of the one or more SGMAs, salts thereof, or combination thereof of 200 ppm to 1,000 ppm.

Embodiment 54 provides the composition of any one of Embodiments 42-53, wherein the composition has a concentration of the one or more SGMAs, salts thereof, or combination thereof of 300 ppm to 700 ppm.

Embodiment 55 provides the composition of any one of Embodiments 42-54, wherein the composition is substantially free of non-malonated steviol glycosides and salts thereof.

Embodiment 56 provides the composition of any one of Embodiments 42-55, wherein the composition further comprises one or more non-malonated steviol glycosides, salts thereof, or a combination thereof.

Embodiment 57 provides the composition of any one of Embodiments 42-56, wherein the composition has a ratio of non-malonated steviol glycosides, salts thereof, or a combination thereof to the one or more SGMAs of 0.001:1 to 1000:1.

Embodiment 58 provides the composition of any one of Embodiments 42-57, wherein the composition has a ratio of non-malonated steviol glycosides, salts thereof, or a combination thereof to the one or more SGMAs of 0.1:1 to 1000:1.

Embodiment 59 provides the composition of any one of Embodiments 42-58, wherein the composition has a ratio of non-malonated steviol glycosides, salts thereof, or a combination thereof to the one or more SGMAs of 2:1 to 1000:1.

Embodiment 60 provides the composition of any one of Embodiments 42-59, wherein the composition further comprises stevioside, rebaudioside A, rebaudioside C, dulcoside A, rebaudioside B, rebaudioside D, rebaudioside E, rebaudioside M, rebaudioside O, rebaudioside N, rebaudioside F, salts thereof, or a combination thereof.

Embodiment 61 provides the composition of any one of Embodiments 42-60, wherein the composition is an aqueous composition.

Embodiment 62 provides the composition of any one of Embodiments 42-61, wherein at least 20 wt % of the composition is water.

Embodiment 63 provides the composition of any one of Embodiments 42-62, wherein the composition has a pH of 1 to 9.

Embodiment 64 provides the composition of any one of Embodiments 42-63, wherein the composition has a pH of 1.7 to 4.

Embodiment 65 provides the composition of any one of Embodiments 42-64, wherein the composition has a pH of 2.5 to 3.5.

Embodiment 66 provides the composition of any one of Embodiments 42-65, wherein the composition has a pH of 1.7 to 2.0.

Embodiment 67 provides the composition of any one of Embodiments 42-66, wherein the composition has a solid form.

Embodiment 68 provides the composition of any one of Embodiments 42-67, wherein the composition is a freeze-dried powder.

Embodiment 69 provides the composition of any one of Embodiments 42-68, wherein the composition further comprises a stability modifier, a stabilizer, a microbial stabilizer, another sweetener, a bulking agent, erythritol, a desiccant, an anti-caking agent, or a combination thereof.

Embodiment 70 provides the composition of any one of Embodiments 42-69, wherein the composition is a sweetener.

Embodiment 71 provides the composition of any one of Embodiments 42-70, wherein the composition is a throw syrup or sweetened beverage concentrate.

Embodiment 72 provides the composition of any one of Embodiments 42-71, wherein the composition is a sweetened beverage.

Embodiment 73 provides the composition of any one of Embodiments 42-72, wherein the composition is a chocolate milk, a tea, an energy drink, a drinkable yogurt, a flavored water, or a combination thereof.

Embodiment 74 provides the composition of any one of Embodiments 42-73, wherein the composition is a carbonated soft drink.

Embodiment 75 provides the composition of any one of Embodiments 42-74, wherein the composition is a solid food stuff.

Embodiment 76 provides the composition of any one of Embodiments 42-75, wherein the composition is a snack bar, a dried fruit product, a cookie, a cereal, a chocolate, a chewing gum, a candy, a cake, a donut, or a combination thereof.

Embodiment 77 provides the composition of any one of Embodiments 42-76, wherein the composition is a pharmaceutical composition, a nutritional supplement, or a dental composition.

Embodiment 78 provides the composition of any one of Embodiments 42-77, wherein

0-5% (wt) of the composition is one or more of quercetin, kaempferol, myricetin, fisetin, galangin, isorhamnetin, pachypodol, rhamnazin, pyranoflavonols, furanoflavonols, luteolin, apigenin, tangeritin, taxifolin (or dihydroquercetin), dihydrokaempferol, hesperetin, naringenin, eriodictyol, homoeriodictyol, genistein, daidzein, glycitein, hesperidin, naringin, rutin, quercitrin, luteolin-glucoside, quercetin-xyloside, cyanidin, delphinidin, malvidin, pelargonidin, peonidin, and petunidin, or

0-3% (wt) of the composition is one or more of malonate, malonic acid, oxalate, oxalic acid, lactate, lactic acid, succinate, succinic acid, malate, malic acid, citrate, and citric acid, or

0-1% (wt) of the composition is one or more of sulfate, sulfuric acid, phosphate, phosphoric acid, nitrate, nitric acid, nitrite, nitrous acid, chloride, hydrochloric acid, ammonia, ammonium, tannic acid, monoglycerides, diglycerides, triglycerides, glucose, fructose, sucrose, galactose, ribose, trehalose, trehalulose, lactose, maltose, isomaltose, isomaltulose, mannose, tagatose, arabinose, rhamnose, xylose, dextrose, erythrose, threose, maltotriose, panose, glycerol, sorbitol, mannitol, xylitol, maltitol, lactitol, erythritol, isomalt, and inositol, or

0-0.5% (wt) of the composition is one or more of tartrate, tartaric acid, pyruvate, pyruvic acid, fumarate, fumaric acid, ascorbic acid, sorbate, sorbic acid, acetate, acetic acid, and chlorophyll, or

a combination thereof.

Embodiment 79 provides the composition of any one of Embodiments 42-78, wherein the composition comprises less than 0.3% (wt) of malonate, malonic acid, oxalate, oxalic acid, lactate, lactic acid, succinate, succinic acid, malate, or malic acid; or less than 0.05% (wt) of pyruvate, pyruvic acid, fumarate, fumaric acid, tartrate, tartaric acid, sorbate, sorbic acid, acetate, or acetic acid; or less than about 0.05% (wt) of chlorophyll.

Embodiment 80 provides the composition of any one of Embodiments 42-79, wherein the composition is free of malonate, malonic acid, oxalate, oxalic acid, lactate, lactic acid, succinate, succinic acid, malate, and malic acid; or is free of pyruvate, pyruvic acid, fumarate, fumaric acid, tartrate, tartaric acid, sorbate, sorbic acid, acetate, and acetic acid; or is chlorophyll-free.

Embodiment 81 provides the composition of any one of Embodiments 42-80, wherein less than 0.1 wt % of the composition is one or more of alanine, arginine, asparagine, aspartic acid, cysteine, glutamine, glutamic acid, glycine, histidine, isoleucine, leucine, lysine, methionine, phenylalanine, proline, serine, threonine, tryptophan, tyrosine, valine, acacia (arabic) gum, agar-agar, algin-alginate, arabynoxylan, beta-glucan, beta mannan, carageenan gum, carob or locust bean gum, fenugreek gum, galactomannans, gellan gum, glucomannan or konjac gum, guar gum, hemicellulose, inulin, karaya gum, pectin, polydextrose, psyllium husk mucilage, resistant starches, tara gum, tragacanth gum, xanthan gum, cellulose, chitin, and chitosan.

Embodiment 82 provides a method of purifying the SGMA of salt thereof any one of Embodiments 1-41 from stevia leaf material, the method comprising:

extracting the stevia leaf material with an extraction solution comprising water, a water-miscible alcohol, or a combination thereof, so that the extraction solution comprises a stevia leaf extract; and

chromatographing the stevia leaf extract, to provide the one or more SGMAs or salts thereof of any one of Embodiments 1-41 and/or the composition of any one of Embodiments 42-81.

Embodiment 83 provides a method of forming the composition comprising one or more steviol glycoside malonic acid esters (SGMAs) or salts thereof of any one of Embodiments 42-81, the method comprising:

purifying one or more SGMAs or salts thereof from a stevia leaf material, comprising
extracting the stevia leaf material with an extraction solution comprising water, a water-miscible alcohol, or a combination thereof, so that the extraction solution comprises a stevia leaf extract, and
chromatographing the stevia leaf extract, to provide the one or more SGMAs or salts thereof of any one of Embodiments 1-41; and

combining the one or more SGMAs or salts thereof with one or more steviol glycosides, to form the composition comprising one or more SGMAs or salts thereof.

Embodiment 84 provides the method of Embodiment 83, wherein the steviol glycosides are extracted from a different stevia leaf material than the stevia leaf material from which the SGMAs or salts thereof are purified.

Embodiment 85 provides the method of any one of Embodiments 82-84, comprising maintaining pH of the extract below a pH of 12 prior to and throughout the chromatographing.

Embodiment 86 provides the method of any one of Embodiments 82-85, comprising maintaining pH of the extract below a pH of 10 prior to and throughout the chromatographing.

Embodiment 87 provides the method of any one of Embodiments 82-86, comprising maintaining pH of the extract below a pH of 8 prior to and throughout the chromatographing.

Embodiment 88 provides the method of any one of Embodiments 82-87, wherein prior to and during the chromatographing, the method is free of treatment with FeCl₃, treatment with Ca(OH)₂, and activated carbon treatment.

Embodiment 89 provides the method of any one of Embodiments 82-88, wherein the chromatographing comprises chromatographing the extraction solution into a buffered solution that has a pH of 1-9.

Embodiment 90 provides the method of any one of Embodiments 82-89, wherein the chromatographing comprises chromatographing the extraction solution into a buffered solution that has a pH of 1-7.

Embodiment 91 provides the method of any one of Embodiments 82-90, wherein the chromatographing comprises ion exchange chromatography, adsorption chromatography, column chromatography, or a combination thereof.

Embodiment 92 provides the method of any one of Embodiments 82-91, wherein the chromatographing comprises anionic resin chromatography.

Embodiment 93 provides the method of Embodiment 92, wherein the anionic resin chromatography comprises

passing the extract through an anionic resin to bind SGMA species thereof;

washing the column to remove un-malonated steviol glycerides therefrom; and

washing the column to remove SGMAs therefrom.

Embodiment 94 provides the method of any one of Embodiments 82-93, wherein the method further comprises further purifying the SGMA after the chromatographing.

Embodiment 95 provides the method of Embodiment 94, wherein the further purification comprises membrane filtration, ion exchange chromatography, adsorption chromatography, column chromatography, activated carbon treatment, crystallization, treatment with FeCl₃, treatment with Ca(OH)₂, or a combination thereof.

Embodiment 96 provides the method of any one of Embodiments 82-95, wherein the method further comprises further processing the SGMA after the chromatographing.

Embodiment 97 provides the method of Embodiment 96, wherein the further processing comprises decolorizing, evaporating, deionizing, concentrating, drying, or a combination thereof.

Embodiment 97 provides the method of any one of Embodiments 82-97, wherein prior to the combining the one or more SGMAs or salts thereof with one or more steviol glycosides, the one or more SGMAs or salts thereof are comprised in a post-chromatography composition, wherein

0-5% (wt) of the post-chromatography composition is one or more of quercetin, kaempferol, myricetin, fisetin, galangin, isorhamnetin, pachypodol, rhamnazin, pyranoflavonols, furanoflavonols, luteolin, apigenin, tangeritin, taxifolin (or dihydroquercetin), dihydrokaempferol, hesperetin, naringenin, eriodictyol, homoeriodictyol, genistein, daidzein, glycitein, hesperidin, naringin, rutin, quercitrin, luteolin-glucoside, quercetin-xyloside, cyanidin, delphinidin, malvidin, pelargonidin, peonidin, and petunidin, or

0-3% (wt) of the post-chromatography composition is one or more of malonate, malonic acid, oxalate, oxalic acid, lactate, lactic acid, succinate, succinic acid, malate, malic acid, citrate, and citric acid, or

0-1% (wt) of the post-chromatography composition is one or more of sulfate, sulfuric acid, phosphate, phosphoric acid, nitrate, nitric acid, nitrite, nitrous acid, chloride, hydrochloric acid, ammonia, ammonium, tannic acid, monoglycerides, diglycerides, triglycerides, glucose, fructose, sucrose, galactose, ribose, trehalose, trehalulose, lactose, maltose, isomaltose, isomaltulose, mannose, tagatose, arabinose, rhamnose, xylose, dextrose, erythrose, threose, maltotriose, panose, glycerol, sorbitol, mannitol, xylitol, maltitol, lactitol, erythritol, isomalt, and inositol, or

0-0.5% (wt) of the post-chromatography composition is one or more of tartrate, tartaric acid, pyruvate, pyruvic acid, fumarate, fumaric acid, ascorbic acid, sorbate, sorbic acid, acetate, acetic acid, and chlorophyll.

Embodiment 98 provides the method of Embodiment 97 wherein the post-chromatography composition comprises less than 0.3% (wt) of malonate, malonic acid, oxalate, oxalic acid, lactate, lactic acid, succinate, succinic acid, malate, or malic acid; or less than 0.05% (wt) of pyruvate, pyruvic acid, fumarate, fumaric acid, tartrate, tartaric acid, sorbate, sorbic acid, acetate, or acetic acid; or less than about 0.05% (wt) of chlorophyll.

Embodiment 99 provides the method of any one of Embodiments 97-98 wherein the post-chromatography composition is free of malonate, malonic acid, oxalate, oxalic acid, lactate, lactic acid, succinate, succinic acid, malate, and malic acid; or is free of pyruvate, pyruvic acid, fumarate, fumaric acid, tartrate, tartaric acid, sorbate, sorbic acid, acetate, and acetic acid; or is chlorophyll-free.

Embodiment 100 provides the method of any one of Embodiments 97-99 wherein less than 0.1 wt % of the post-chromatography composition is one or more of alanine, arginine, asparagine, aspartic acid, cysteine, glutamine, glutamic acid, glycine, histidine, isoleucine, leucine, lysine, methionine, phenylalanine, proline, serine, threonine, tryptophan, tyrosine, valine, acacia (arabic) gum, agar-agar, algin-alginate, arabynoxylan, beta-glucan, beta mannan, carageenan gum, carob or locust bean gum, fenugreek gum, galactomannans, gellan gum, glucomannan or konjac gum, guar gum, hemicellulose, inulin, karaya gum, pectin, polydextrose, psyllium husk mucilage, resistant starches, tara gum, tragacanth gum, xanthan gum, cellulose, chitin, and chitosan.

Embodiment 101 provides a method of making a sweetener or sweetened composition, the method comprising:

combining an SGMA component that comprises at least 80 wt % of one or more steviol glycoside malonic acid esters (SGMAs) or salts thereof with a second component that comprises at least one sweetener chosen from steviol glycosides, mogrosides, a sugar, aspartame, sucralose, neotame, and brazzein.

Embodiment 102 provides the method of Embodiment 101, wherein the SGMA component comprises at least 90 wt % of the SGMAs.

Embodiment 103 provides the method of any one of Embodiments 101-102, wherein the sugar is at least one chosen from sucrose, glucose, fructose, and psicose.

Embodiment 104 provides the method of any one of Embodiments 101-103, wherein

0-5% (wt) of the SGMA component is one or more of quercetin, kaempferol, myricetin, fisetin, galangin, isorhamnetin, pachypodol, rhamnazin, pyranoflavonols, furanoflavonols, luteolin, apigenin, tangeritin, taxifolin (or dihydroquercetin), dihydrokaempferol, hesperetin, naringenin, eriodictyol, homoeriodictyol, genistein, daidzein, glycitein, hesperidin, naringin, rutin, quercitrin, luteolin-glucoside, quercetin-xyloside, cyanidin, delphinidin, malvidin, pelargonidin, peonidin, and petunidin, or

0-3% (wt) of the SGMA component is one or more of malonate, malonic acid, oxalate, oxalic acid, lactate, lactic acid, succinate, succinic acid, malate, malic acid, citrate, and citric acid, or

0-1% (wt) of the SGMA component is one or more of sulfate, sulfuric acid, phosphate, phosphoric acid, nitrate, nitric acid, nitrite, nitrous acid, chloride, hydrochloric acid, ammonia, ammonium, tannic acid, monoglycerides, diglycerides, triglycerides, glucose, fructose, sucrose, galactose, ribose, trehalose, trehalulose, lactose, maltose, isomaltose, isomaltulose, mannose, tagatose, arabinose, rhamnose, xylose, dextrose, erythrose, threose, maltotriose, panose, glycerol, sorbitol, mannitol, xylitol, maltitol, lactitol, erythritol, isomalt, and inositol, or

0-0.5% (wt) of the SGMA component is one or more of tartrate, tartaric acid, pyruvate, pyruvic acid, fumarate, fumaric acid, ascorbic acid, sorbate, sorbic acid, acetate, acetic acid, and chlorophyll.

Embodiment 105 provides the method of any one of Embodiments 101-104 wherein the SGMA component comprises less than 0.3% (wt) of malonate, malonic acid, oxalate, oxalic acid, lactate, lactic acid, succinate, succinic acid, malate, or malic acid; or less than 0.05% (wt) of pyruvate, pyruvic acid, fumarate, fumaric acid, tartrate, tartaric acid, sorbate, sorbic acid, acetate, or acetic acid; or less than about 0.05% (wt) of chlorophyll.

Embodiment 106 provides the method of any one of Embodiments 101-105, wherein the SGMA component is free of malonate, malonic acid, oxalate, oxalic acid, lactate, lactic acid, succinate, succinic acid, malate, and malic acid; or is free of pyruvate, pyruvic acid, fumarate, fumaric acid, tartrate, tartaric acid, sorbate, sorbic acid, acetate, and acetic acid; or is chlorophyll-free.

Embodiment 107 provides the method of any one of Embodiments 101-106, wherein less than 0.1 wt % of the SGMA component is one or more of alanine, arginine, asparagine, aspartic acid, cysteine, glutamine, glutamic acid, glycine, histidine, isoleucine, leucine, lysine, methionine, phenylalanine, proline, serine, threonine, tryptophan, tyrosine, valine, acacia (arabic) gum, agar-agar, algin-alginate, arabynoxylan, beta-glucan, beta mannan, carageenan gum, carob or locust bean gum, fenugreek gum, galactomannans, gellan gum, glucomannan or konjac gum, guar gum, hemicellulose, inulin, karaya gum, pectin, polydextrose, psyllium husk mucilage, resistant starches, tara gum, tragacanth gum, xanthan gum, cellulose, chitin, and chitosan.

Embodiment 108 provides the method of any one of Embodiments 101-107, wherein the sweetened composition is a beverage or beverage concentrate and the method further comprises dissolving at least a portion of the SGMA component to provide an aqueous solution.

Embodiment 109 provides a beverage comprising:

a steviol glycoside malonic acid ester (SGMA) or salt thereof having the structure:

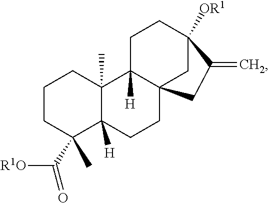

or a salt thereof;

wherein

at each occurrence R¹ is independently chosen from —H, a malonic acid ester or a salt thereof, and a glycosidically-bonded primary sugar,

at each occurrence the primary sugar is independently chosen from glucose, xylose, and rhamnose, and at each occurrence the primary sugar independently optionally comprises a secondary sugar glycosidically-bonded to the primary sugar, a malonic acid ester or a salt thereof bonded to the primary sugar, or a combination thereof,

at each occurrence the secondary sugar, if present, is independently chosen from glucose, xylose, and rhamnose, and at each occurrence the secondary sugar independently optionally comprises a tertiary sugar glycosidically-bonded to the secondary sugar, a malonic acid ester or a salt thereof bonded to the secondary sugar, or a combination thereof,

at each occurrence the tertiary sugar, if present, is independently chosen from glucose, xylose, and rhamnose, and at each occurrence the tertiary sugar independently optionally comprises a malonic acid ester or a salt thereof bonded to the tertiary sugar,

the SGMA comprises at least one of the primary sugars and at least one of the malonic acid ester groups or a salt thereof,

the beverage has a concentration of the one or more SGMAs, salts thereof, or combination thereof of 200 ppm to 1,000 ppm, and

the composition comprises
less than 0.3 wt % of malonate, malonic acid, oxalate, oxalic acid, lactate, lactic acid, succinate, succinic acid, malate, or malic acid, or
less than 0.05 wt % of pyruvate, pyruvic acid, fumarate, fumaric acid, tartrate, tartaric acid, sorbate, sorbic acid, acetate, or acetic acid, or less than about 0.05 wt % of chlorophyll.

Embodiment 110 provides the SGMA or salt thereof, composition, or method of any one or any combination of Embodiments 1-109 optionally configured such that all elements or options recited are available to use or select from.

1. A composition comprising:
one or more steviol glycoside malonic acid esters (SGMAs) or salts thereof;
wherein
0-5% (wt) of the composition is one or more of quercetin, kaempferol, myricetin, fisetin, galangin, isorhamnetin, pachypodol, rhamnazin, pyranoflavonols, furanoflavonols, luteolin, apigenin, tangeritin, taxifolin (or dihydroquercetin), dihydrokaempferol, hesperetin, naringenin, eriodictyol, homoeriodictyol, genistein, daidzein, glycitein, hesperidin, naringin, rutin, quercitrin, luteolin-glucoside, quercetin-xyloside, cyanidin, delphinidin, malvidin, pelargonidin, peonidin, and petunidin, or
0-3% (wt) of the composition is one or more of malonate, malonic acid, oxalate, oxalic acid, lactate, lactic acid, succinate, succinic acid, malate, malic acid, citrate, and citric acid, or
0-1% (wt) of the composition is one or more of sulfate, sulfuric acid, phosphate, phosphoric acid, nitrate, nitric acid, nitrite, nitrous acid, chloride, hydrochloric acid, ammonia, ammonium, tannic acid, monoglycerides, diglycerides, triglycerides, glucose, fructose, sucrose, galactose, ribose, trehalose, trehalulose, lactose, maltose, isomaltose, isomaltulose, mannose, tagatose, arabinose, rhamnose, xylose, dextrose, erythrose, threose, maltotriose, panose, glycerol, sorbitol, mannitol, xylitol, maltitol, lactitol, erythritol, isomalt, and inositol, or
0-0.5% (wt) of the composition is one or more of tartrate, tartaric acid, pyruvate, pyruvic acid, fumarate, fumaric acid, ascorbic acid, sorbate, sorbic acid, acetate, acetic acid, and chlorophyll.

2. The composition of claim 1, wherein
0-5% (wt) of the composition is one or more of quercetin, kaempferol, myricetin, fisetin, galangin, isorhamnetin, pachypodol, rhamnazin, pyranoflavonols, furanoflavonols, luteolin, apigenin, tangeritin, taxifolin (or dihydroquercetin), dihydrokaempferol, hesperetin, naringenin, eriodictyol, homoeriodictyol, genistein, daidzein, glycitein, hesperidin, naringin, rutin, quercitrin, luteolin-glucoside, quercetin-xyloside, cyanidin, delphinidin, malvidin, pelargonidin, peonidin, and petunidin; and
0-3% (wt) of the composition is one or more of malonate, malonic acid, oxalate, oxalic acid, lactate, lactic acid, succinate, succinic acid, malate, malic acid, citrate, and citric acid; and
0-1% (wt) of the composition is one or more of sulfate, sulfuric acid, phosphate, phosphoric acid, nitrate, nitric acid, nitrite, nitrous acid, chloride, hydrochloric acid, ammonia, ammonium, tannic acid, monoglycerides, diglycerides, triglycerides, glucose, fructose, sucrose, galactose, ribose, trehalose, trehalulose, lactose, maltose, isomaltose, isomaltulose, mannose, tagatose, arabinose, rhamnose, xylose, dextrose, erythrose, threose, maltotriose, panose, glycerol, sorbitol, mannitol, xylitol, maltitol, lactitol, erythritol, isomalt, and inositol; and
0-0.5% (wt) of the composition is one or more of tartrate, tartaric acid, pyruvate, pyruvic acid, fumarate, fumaric acid, ascorbic acid, sorbate, sorbic acid, acetate, acetic acid, and chlorophyll.

3. The composition of claim 1, wherein the one or more SGMAs, salts thereof, or the combination thereof are 10 wt % to 100 wt % of the composition.

4. The composition of claim 1, wherein the one or more SGMAs, salts thereof, or the combination thereof are 0.01 wt % to 30 wt % of the composition.

5. The composition of claim 1, wherein the composition is an aqueous composition having a pH of 1.7 to 4.

6. The composition of claim 1, wherein the composition is a throw syrup, a sweetened beverage, or a carbonated soft drink.

7. The composition of claim 1, wherein the composition comprises less than 0.3% (wt) of malonate, malonic acid, oxalate, oxalic acid, lactate, lactic acid, succinate, succinic acid, malate, or malic acid; or less than 0.05% (wt) of pyruvate, pyruvic acid, fumarate, fumaric acid, tartrate, tartaric acid, sorbate, sorbic acid, acetate, or acetic acid; or less than about 0.05% (wt) of chlorophyll.

8. The composition of claim 1, wherein the composition is free of malonate, malonic acid, oxalate, oxalic acid, lactate, lactic acid, succinate, succinic acid, malate, and malic acid; or is free of pyruvate, pyruvic acid, fumarate, fumaric acid, tartrate, tartaric acid, sorbate, sorbic acid, acetate, and acetic acid; or is chlorophyll-free.

9. The composition of claim 1, wherein less than 0.1 wt % of the composition is one or more of alanine, arginine, asparagine, aspartic acid, cysteine, glutamine, glutamic acid, glycine, histidine, isoleucine, leucine, lysine, methionine, phenylalanine, proline, serine, threonine, tryptophan, tyrosine, valine, acacia (arabic) gum, agar-agar, algin-alginate, arabynoxylan, beta-glucan, beta mannan, carageenan gum, carob or locust bean gum, fenugreek gum, galactomannans, gellan gum, glucomannan or konjac gum, guar gum, hemicellulose, inulin, karaya gum, pectin, polydextrose, psyllium husk mucilage, resistant starches, tara gum, tragacanth gum, xanthan gum, cellulose, chitin, and chitosan.

10. The composition of claim 1, wherein the composition is a freeze-dried powder.

11. The composition of claim 1, wherein the composition is a sweetener.

12. The composition of claim 1, wherein the SGMA or salt thereof has 1 to 3 malonic acid ester groups or salts thereof.

13. The composition of claim 1, wherein the SGMA or salt thereof has the structure: 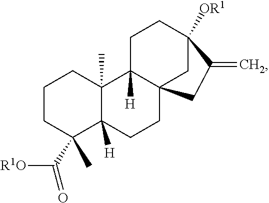
or a salt thereof;
wherein
at each occurrence R¹ is independently chosen from —H, a malonic acid ester or a salt thereof, and a glycosidically-bonded primary sugar,
at each occurrence the primary sugar is independently chosen from glucose, xylose, and rhamnose, and at each occurrence the primary sugar independently optionally comprises a secondary sugar glycosidically-bonded to the primary sugar, a malonic acid ester or a salt thereof bonded to the primary sugar, or a combination thereof,
at each occurrence the secondary sugar, if present, is independently chosen from glucose, xylose, and rhamnose, and at each occurrence the secondary sugar independently optionally comprises a tertiary sugar glycosidically-bonded to the secondary sugar, a malonic acid ester or a salt thereof bonded to the secondary sugar, or a combination thereof,
at each occurrence the tertiary sugar, if present, is independently chosen from glucose, xylose, and rhamnose, and at each occurrence the tertiary sugar independently optionally comprises a malonic acid ester or a salt thereof bonded to the tertiary sugar, and
the SGMA comprises at least one of the primary sugars and at least one of the malonic acid ester groups or a salt thereof

14. A method of forming a composition comprising one or more steviol glycoside malonic acid esters (SGMAs) or salts thereof, the method comprising:
purifying one or more SGMAs or salts thereof from a stevia leaf material, comprising
extracting the stevia leaf material with an extraction solution comprising water, a water-miscible alcohol, or a combination thereof, so that the extraction solution comprises a stevia leaf extract, and
chromatographing the stevia leaf extract, to provide the one or more SGMAs or salts thereof; and
combining the one or more SGMAs or salts thereof with one or more steviol glycosides, to form the composition comprising one or more SGMAs or salts thereof.

15. The method of claim 14, wherein the steviol glycosides are extracted from a different stevia leaf material than the stevia leaf material from which the SGMAs or salts thereof are purified.

16. The method of claim 14, comprising maintaining pH of the extract below a pH of 10 prior to and throughout the chromatographing.

17. The method of claim 14, wherein prior to and during the chromatographing, the method is free of treatment with FeCl₃, treatment with Ca(OH)₂, and activated carbon treatment.

18. The method of claim 14, wherein the chromatographing comprises chromatographing the extraction solution into a buffered solution that has a pH of 1-7.

19. The method of claim 14, wherein the chromatographing comprises anionic resin chromatography comprising
passing the extract through an anionic resin to bind SGMA species thereof;
washing the column to remove un-malonated steviol glycerides therefrom; and
washing the column to remove SGMAs therefrom.

20. The method of claim 14, wherein the method further comprises further purifying the SGMA after the chromatographing, the further purifying comprising membrane filtration, ion exchange chromatography, adsorption chromatography, column chromatography, activated carbon treatment, crystallization, treatment with FeCl₃, treatment with Ca(OH)₂, or a combination thereof.

21. A method of making a sweetener or sweetened composition, the method comprising:
combining an SGMA component that comprises at least 80 wt % of one or more steviol glycoside malonic acid esters (SGMAs) or salts thereof with a second component that comprises at least one sweetener chosen from steviol glycosides, mogrosides, a sugar, aspartame, sucralose, neotame, and brazzein.

22. The method of claim 21, wherein the SGMA component comprises at least 90 wt % of the SGMAs.

23. The method of claim 21, wherein the sugar is at least one chosen from sucrose, glucose, fructose, and psicose.

24. The method of claim 21, wherein
0-5% (wt) of the SGMA component is one or more of quercetin, kaempferol, myricetin, fisetin, galangin, isorhamnetin, pachypodol, rhamnazin, pyranoflavonols, furanoflavonols, luteolin, apigenin, tangeritin, taxifolin (or dihydroquercetin), dihydrokaempferol, hesperetin, naringenin, eriodictyol, homoeriodictyol, genistein, daidzein, glycitein, hesperidin, naringin, rutin, quercitrin, luteolin-glucoside, quercetin-xyloside, cyanidin, delphinidin, malvidin, pelargonidin, peonidin, and petunidin, or
0-3% (wt) of the SGMA component is one or more of malonate, malonic acid, oxalate, oxalic acid, lactate, lactic acid, succinate, succinic acid, malate, malic acid, citrate, and citric acid, or
0-1% (wt) of the SGMA component is one or more of sulfate, sulfuric acid, phosphate, phosphoric acid, nitrate, nitric acid, nitrite, nitrous acid, chloride, hydrochloric acid, ammonia, ammonium, tannic acid, monoglycerides, diglycerides, triglycerides, glucose, fructose, sucrose, galactose, ribose, trehalose, trehalulose, lactose, maltose, isomaltose, isomaltulose, mannose, tagatose, arabinose, rhamnose, xylose, dextrose, erythrose, threose, maltotriose, panose, glycerol, sorbitol, mannitol, xylitol, maltitol, lactitol, erythritol, isomalt, and inositol, or
0-0.5% (wt) of the SGMA component is one or more of tartrate, tartaric acid, pyruvate, pyruvic acid, fumarate, fumaric acid, ascorbic acid, sorbate, sorbic acid, acetate, acetic acid, and chlorophyll.

25. The method of claim 21, wherein the sweetened composition is a beverage or beverage concentrate and the method further comprises dissolving at least a portion of the SGMA component to provide an aqueous solution.

26. A beverage comprising:
a steviol glycoside malonic acid ester (SGMA) or salt thereof having the structure: 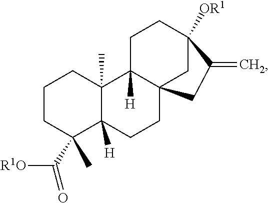
or a salt thereof;
wherein
at each occurrence R¹ is independently chosen from —H, a malonic acid ester or a salt thereof, and a glycosidically-bonded primary sugar,
at each occurrence the primary sugar is independently chosen from glucose, xylose, and rhamnose, and at each occurrence the primary sugar independently optionally comprises a secondary sugar glycosidically-bonded to the primary sugar, a malonic acid ester or a salt thereof bonded to the primary sugar, or a combination thereof,
at each occurrence the secondary sugar, if present, is independently chosen from glucose, xylose, and rhamnose, and at each occurrence the secondary sugar independently optionally comprises a tertiary sugar glycosidically-bonded to the secondary sugar, a malonic acid ester or a salt thereof bonded to the secondary sugar, or a combination thereof,
at each occurrence the tertiary sugar, if present, is independently chosen from glucose, xylose, and rhamnose, and at each occurrence the tertiary sugar independently optionally comprises a malonic acid ester or a salt thereof bonded to the tertiary sugar,
the SGMA comprises at least one of the primary sugars and at least one of the malonic acid ester groups or a salt thereof,
the beverage has a concentration of the one or more SGMAs, salts thereof, or combination thereof of 200 ppm to 1,000 ppm, and
the composition comprises
less than 0.3 wt % of malonate, malonic acid, oxalate, oxalic acid, lactate, lactic acid, succinate, succinic acid, malate, or malic acid, or
less than 0.05 wt % of pyruvate, pyruvic acid, fumarate, fumaric acid, tartrate, tartaric acid, sorbate, sorbic acid, acetate, or acetic acid, or
less than about 0.05 wt % of chlorophyll.
